(19) United States
(12) Patent Application Publication
(10) Pub. No.: US 2018/0150838 A1
(43) Pub. Date: May 31, 2018

(54) ELECTRONIC PAYMENT ACCEPTANCE DEVICE

(71) Applicant: Yello Company Limited, Guernsey (GB)

(72) Inventors: Michiel Reinier Ausems, Paris (FR); Daniel Maurice-Vallerey, Paris (FR)

(21) Appl. No.: 15/823,442

(22) Filed: Nov. 27, 2017

Related U.S. Application Data
(60) Provisional application No. 62/427,094, filed on Nov. 28, 2016.

(51) Int. Cl. G06Q 20/40; G06T 3/40

(52) U.S. Cl. CPC G06Q 20/4012; G06F 21/84; G06T 3/40

(57) ABSTRACT

The electronic payment acceptance devices provide a security-status-indicating GUI via a display window resident therein. The security-status-indicating GUI includes a security message element that provides an indication of whether the electronic payment acceptance device is operating in a secure or an unsecure mode. The security-status-indicating GUI may also include a security message element that may be displayed at random locations on the display window. The modified GUI may be modified from a first size provided by a software application running on electronic payment acceptance device the to a second size. The second size may allow for concurrent display of the security message element and the modified GUI on the security-status-indicating GUI.

### RELATED APPLICATION

This application is a non-provisional of, and claims priority to, U.S. Provisional Patent Application No. 62/427,094 entitled “YELLOPAD” filed Nov. 28, 2016, which is incorporated by reference, in its entirety, herein.

### BACKGROUND

Payment acceptance terminals offered by retail establishments are typically limited in their capability due to, for example, various security concerns and processing limitations.

### SUMMARY

Disclosed herein are electronic payment acceptance devices that offer a plurality of functionalities. The electronic payment acceptance devices disclosed herein provide a display window by which a user may interact with various graphic user interfaces to, for example, conduct a financial transaction (e.g., purchase an item or service), play a game, or search for information regarding, for example, an item to be purchased. In some cases, the electronic payment acceptance devices disclosed herein may function as an e-commerce device by which a retail or brick-and-mortar store may conduct e-commerce-like transactions (e.g., may enable internet browsing of an online catalog for the retail store and acceptance of payment or credit-card transactions).

The electronic payment acceptance devices disclosed herein may provide a security-status-indicating GUI via a display device (e.g., screen or touch screen) resident therein. The security-status-indicating GUI may include a security message element that may provide an indication that the electronic payment acceptance device is operating in a secure mode or an unsecure mode. The security message element may be displayed as, for example, a rectangle occupying a portion of display window but not obscuring a modified GUI that is provided by a software application running on the electronic payment acceptance device. The security message element may be displayed at random locations on the display window. It may also appear in any color or include any type of message.

The modified GUI may be provided by a software application running on the electronic payment acceptance device (e.g., electronic payment application, Internet browser, online catalog, e-commerce application, etc.). The modified GUI may be modified from a first size provided by the software application to a second size. The second size may allow for concurrent display of the security message element and the modified GUI on the security-status-indicating GUI. In some instances, the modified GUI may include a PIN entry graphic element and a position of the PIN entry graphic element on the modified GUI may be randomly determined (e.g., every time the modified GUI is provided to the user, it may be in a position that is randomly determined). On some occasions, a privacy screen obscures a portion of the security-status-indicating GUI when the electronic payment acceptance device is operating in a secure mode to onlookers who are not positioned directly above (e.g., on the side or behind) the electronic payment acceptance device.

### BRIEF DESCRIPTION OF THE DRAWINGS

The present invention is illustrated by way of example, and not limitation, in the figures of the accompanying drawings in which:

FIG. 1A provides a front plan view of an exemplary electronic payment acceptance device, in accordance with the present invention;

FIG. 1B, provides a back plan view of exemplary electronic payment acceptance device, in accordance with the present invention;

FIG. 1C provides a first perspective view of exemplary electronic payment acceptance device, in accordance with the present invention;

FIG. 1D provides a second perspective view of exemplary electronic payment acceptance device, in accordance with the present invention;

FIG. 2 provides a diagram of an exemplary system diagram for internal components of electronic payment acceptance device, in accordance with the present invention;

FIG. 3 is a flowchart illustrating an exemplary process for providing a GUI and a security message to a display device such as display window, in accordance with the present invention;

FIG. 4A-FIG. 4D are screenshots of various interfaces provided by the electronic payment acceptance device, in accordance with the present invention; and

FIG. 5A-FIG. 5V are screenshots of a series of security-status-indicating GUIs, in accordance with the present invention.

Throughout the drawings, the same reference numerals and characters, unless otherwise stated, are used to denote like features, elements, components, or portions of the illustrated embodiments. Moreover, while the subject invention will now be described in detail with reference to the drawings, the description is done in connection with the illustrative embodiments. It is intended that changes and modifications can be made to the described embodiments without departing from the true scope and spirit of the subject invention as defined by the appended claims.

Written Description

Disclosed herein are electronic payment acceptance devices in form of a phablet/tablet that offers secure PIN entry and, in many instances, includes universal bankcard EMV PCI PTS payment acceptance capability. Electronic payment acceptance device may perform one or more of the following when accepting financial and/or transaction information:
1. activate an optical privacy shield on a display screen during PIN entry, online banking, or other sensitive activities where privacy may be desired;
2. display a PIN pad at random positions on the screen/display device of the electronic payment acceptance device (e.g., 5 positions, with one and a half row and column difference to make it as hard as possible to guess the number by looking at (or filming and then analyzing) the position of a user's finger (or fingerprint) on the touch panel);
3. disconnect the camera and any recording device present on the electronic payment acceptance device during the PIN entry process (this may be enabled by a secure processor (e.g., a K81 security processor) driving all peripherals);
4. conduct operations in three PIN Entry Transaction Security (PTS) secure modes so that the electronic payment acceptance device is PIN ENTRY secure. PIN ENTRY secure mode may be enabled because they cannot be changed as they are part of the PCI PTS firmware and approval for the electronic payment acceptance device 100 generation; and
5. support different color schemes of a light-emitting element to confirm the fact that the electronic payment acceptance device 100 operates in the PTS security mode to make it possible to use different colors of emitted light for different products/markets/customers according to, for example, merchant, product, retailer, manufacturer, and/or customer preference.

Each of the modes may be characterized by a secure processor driving or managing operations performed by the electronic payment acceptance device and/or the presence and color of a security message that may move randomly on a GUI requesting personal or sensitive information (the security message may be randomly displayed when, for example the electronic payment acceptance device wakes up, each time a new GUI page is displayed, or following expiration of a time interval (e.g., 30 seconds, 1 minute, etc.)) This may prevent criminals or other bad actors from attempting to cover up the portion of a display screen that provides the security message (because doing so would sacrifice too much of the display screen and adversely effect display of UIs thereon (which would be noticeable to a user or customer)). Additionally or alternatively, the secure processor may control the color and pattern of light emitted by the light-emitting element.

Exemplary electronic payment acceptance devices offer three exemplary modes of operation:
1) Mode One: Electronic payment acceptance device may operate in a Secure PIN Entry Open Application Mode (SPENOAM). In one embodiment, operation in this mode may be facilitated by instructions provided in Android code, or the like, running on a CPU (e.g., a iMX6 CPU) resident in the electronic payment acceptance device. Operation in this mode may allow any Android-compatible application available from, for example, the Google Android Play Store to securely run on the terminal by, for example, displaying a security message in a random location on a display window while displaying a security message (e.g., text saying “Do not enter your PIN code.”) A person of skill in the art will recognize that any coding language and/or store from which software applications may be downloaded may be used in place of Android code or the Google Android Play Store. In many instances these security messages are not watermarks and do not overlay a GUI/display provided by a software application running on the electronic payment acceptance device. A size of a GUI provided by the software application may be proportionally reduced to accommodate display of the security message concurrently with the GUI so that, for example, functionality and/or aesthetics of the GUI provided by the software application is not sacrificed by display of the security message. In one example, a security message may be in the form of a rectangle of 80 pixels on a display and the size of the GUI provided by the software application may be proportionally reduced by 80 pixels. This way there is no information from the GUI provided by the software application lost.
2) Mode Two: The Secure PIN Entry Transition and Information Mode (SPENIM): The electronic payment acceptance device may operate in this mode after leaving the Limited Open Application Mode and before entering a Secure PIN Entry Mode. When in this mode, a light-emitting element provided by the electronic payment acceptance device may be a solid color (e.g., yellow). The light-emitting element may be directly driven by a secure processor (not by the iMX6).
3) Mode Three: The Secure PIN Entry Mode (SEPIM). This mode is driven by FreeRTOS running on the secure processor and an FPGA coupled thereto may assume control of a display window resident in the electronic payment acceptance device. At this point the display window may show a PIN Pad at a random position on a GUI screen and, in some instances, the light-emitting element may change to different color (e.g., green). The electronic payment acceptance device may securely enable peer-to-peer payments via one or more smart card readers (e.g., EMV PCI PTS smart card readers) integrated into the same electronic payment acceptance device. In some instances, the electronic payment acceptance device supports a customer ratings system with an application built into the terminal. Cardholders can rate the consumer experience during that particular transaction using built-in tools. The electronic payment acceptance device may also support rating of the customer by the merchant upon completion of the transaction, using a system built into the electronic payment acceptance device.

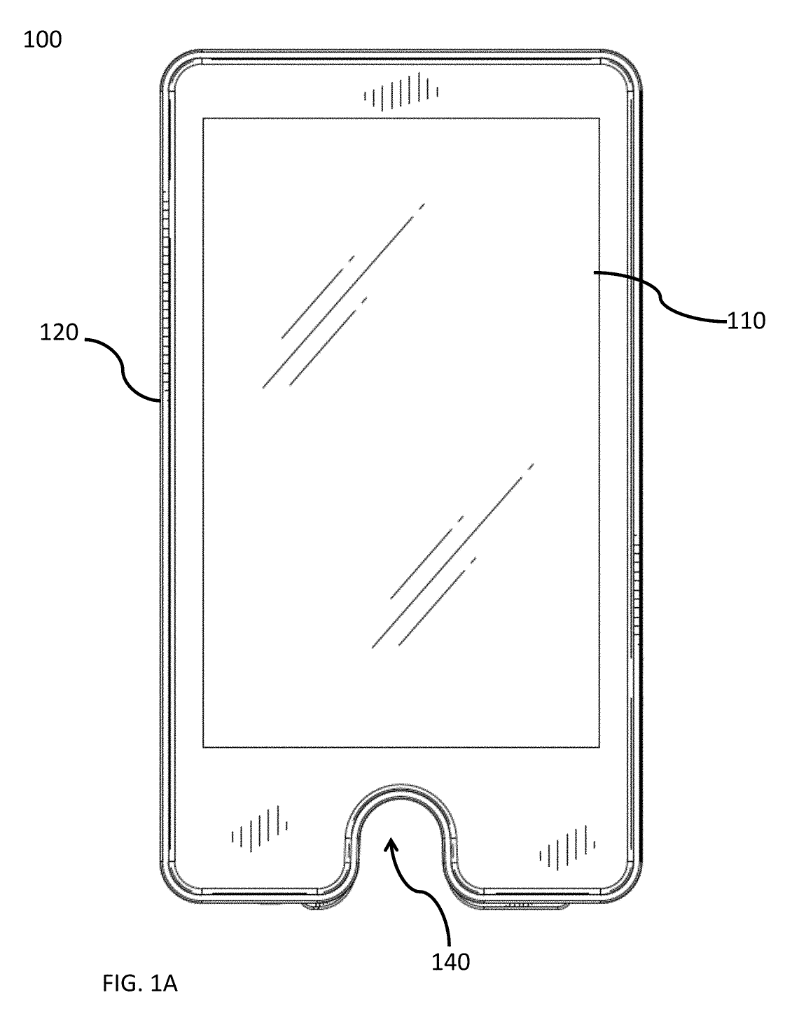

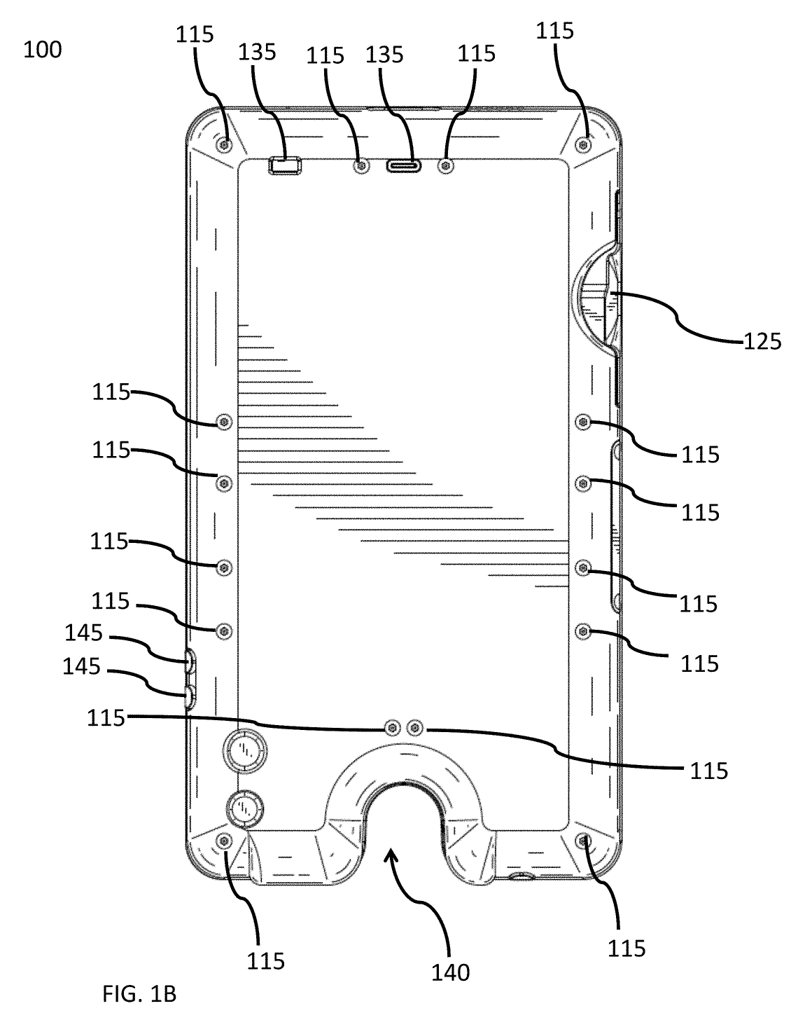

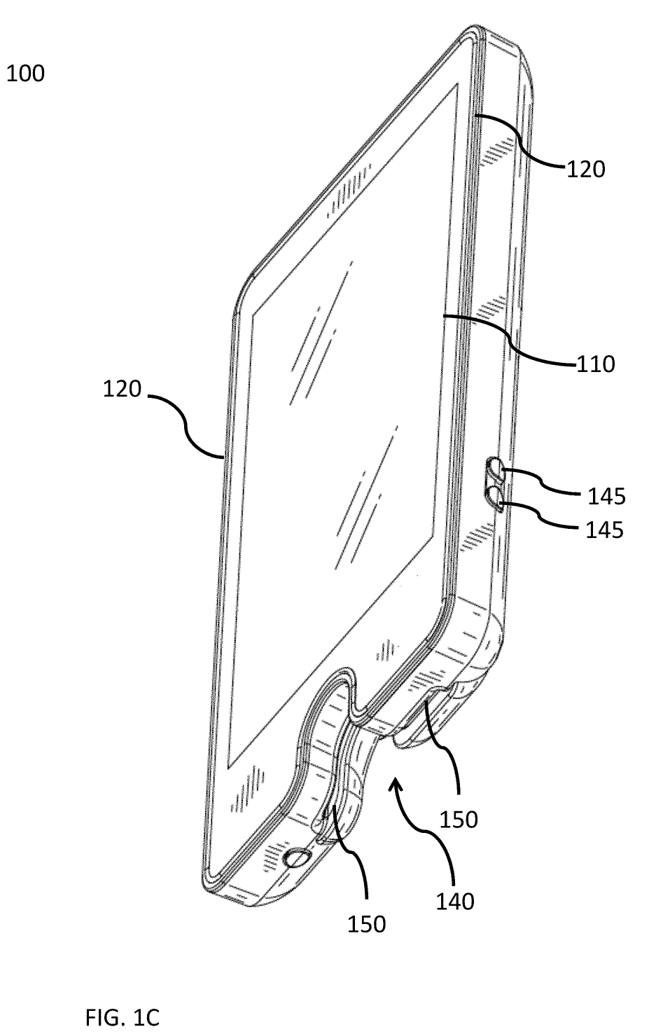

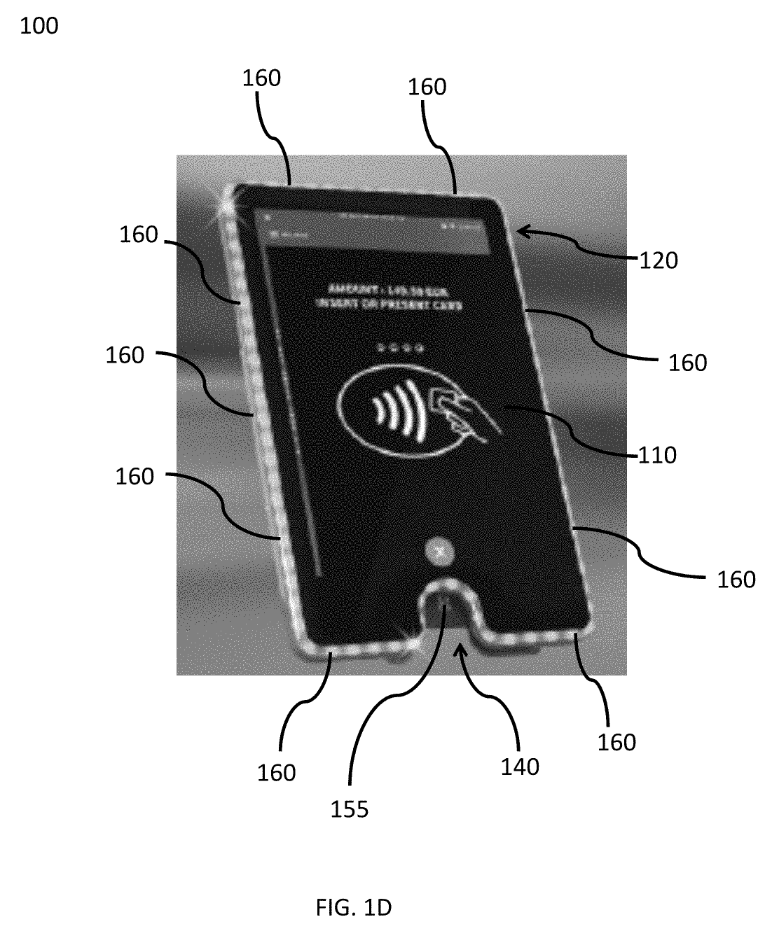

FIGS. 1A-1D provide various views of an exemplary electronic payment acceptance device 100. More specifically, FIG. 1A provides a front plan view of an exemplary electronic payment acceptance device 100, FIG. 1B, provides a back plan view of exemplary electronic payment acceptance device 100, FIG. 1C provides a first perspective view of exemplary electronic payment acceptance device 100, and FIG. 1D provides a second perspective view of exemplary electronic payment acceptance device 100.

Electronic payment acceptance device 100 includes a display window 110, a plurality of attachment mechanisms 115, a light-emitting array 120, a first card slot 125, a plurality of ports 135, a notch 140, a plurality of manual operation buttons 145, a second card slot 150, and a plurality of LEDs. Display window 110 maybe any display configured and/or adapted to provide a graphic user interface (GUI). In some instances, display window 110 may be enabled to receive direct user input as may be the case with, for example, a display and may be enabled to receive input from the user via the user touching or otherwise causing contact with display window 110 and/or a portion thereof.

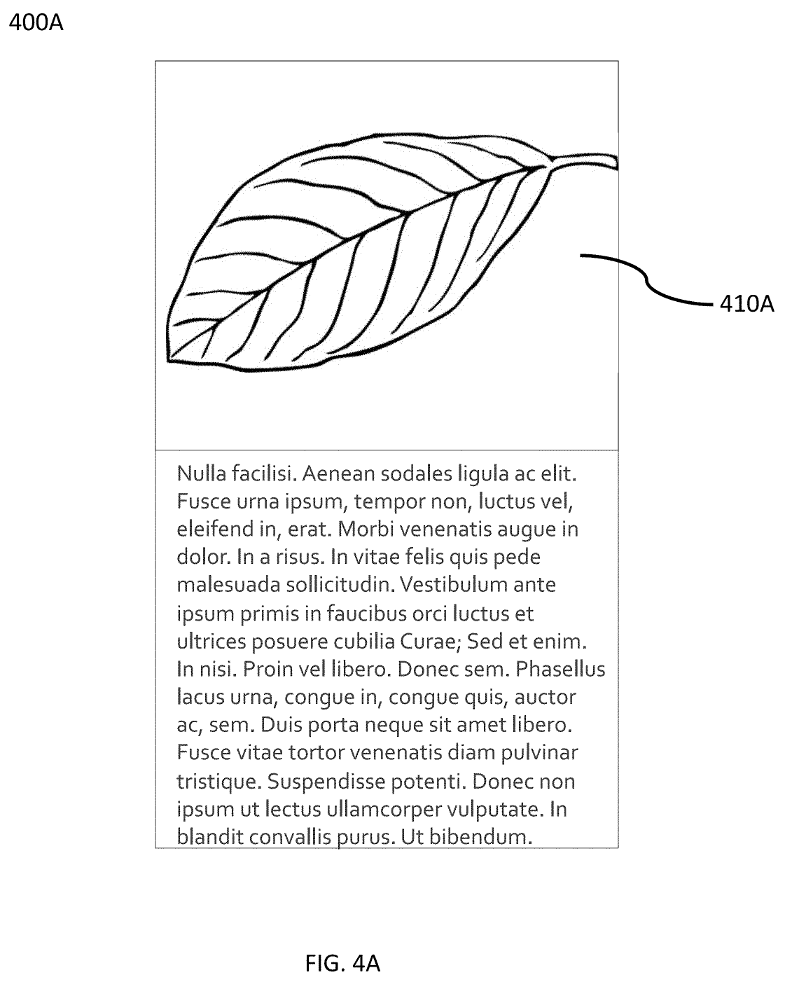

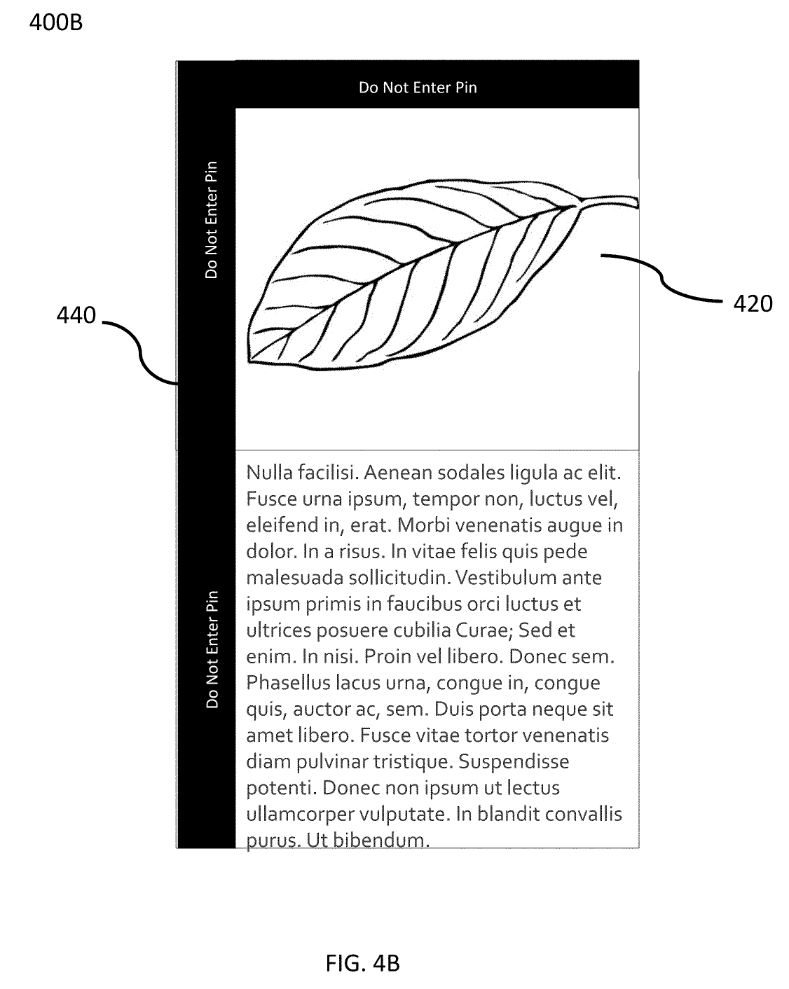

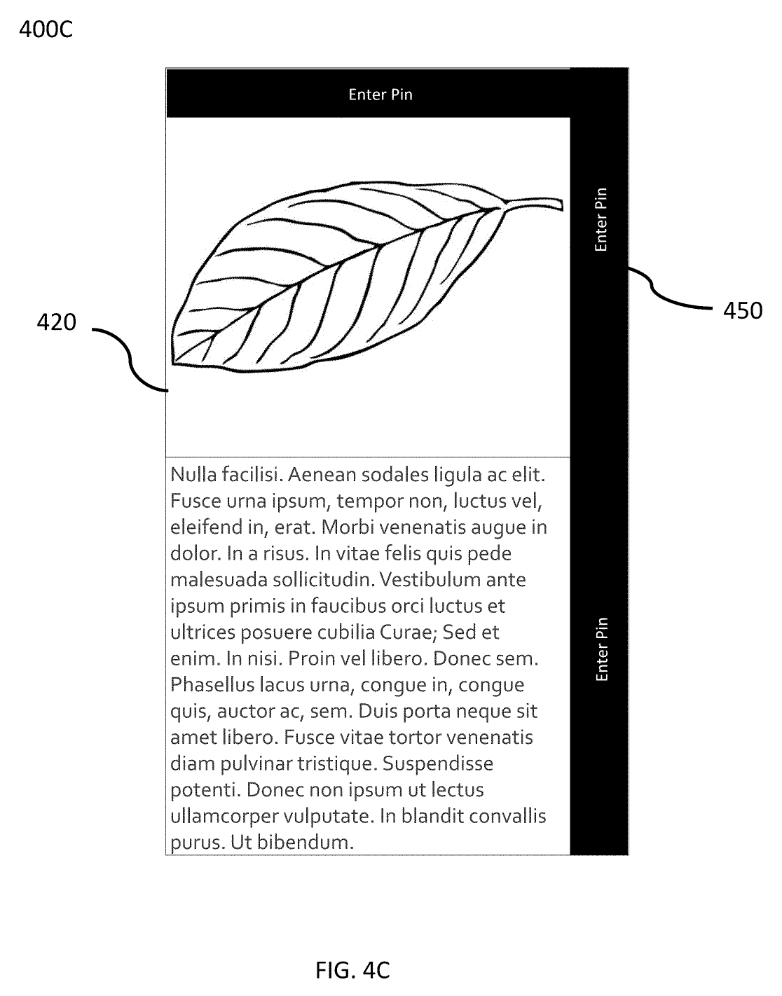

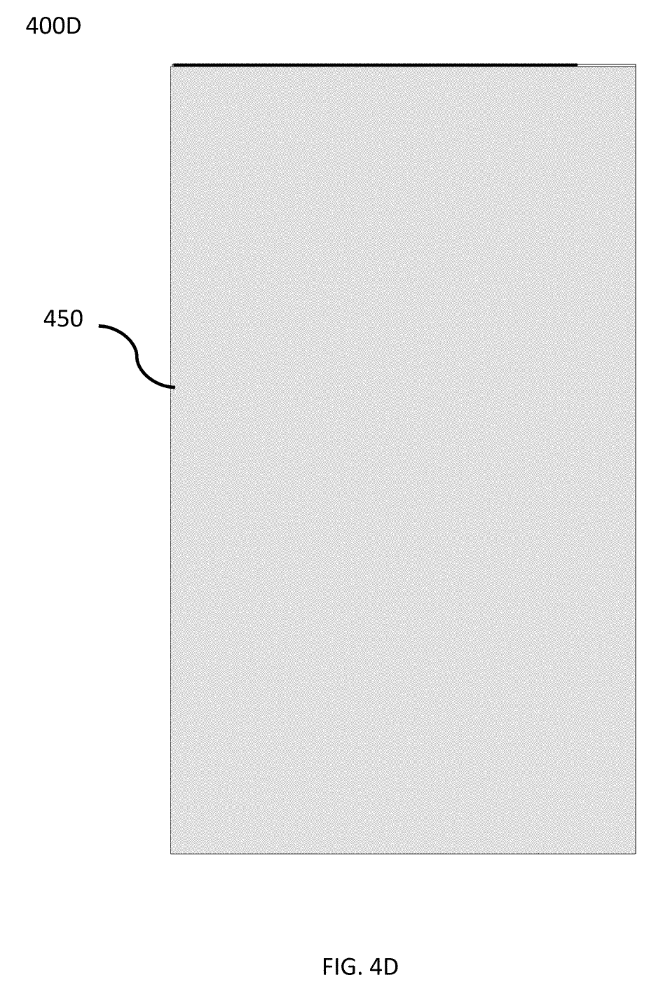

In some instances, display window 110 and/or a portion thereof may be coated or otherwise adapted to include a filter or layer of material (not shown) that is responsive to light provided by, for example, light-emitting array 120, which may include multiple light-emitting devices 160 shown in FIG. 1D. Exemplary light-emitting devices 160 include, but are not limited to, light emitting diodes (LEDs) that may be configured to emit a single, or multiple, colors, (i.e., frequency and/or wavelength) of light. In some instances, this filter and/or layer may be a layer of small particles (in some cases, Nano particles) that reflect the light so as to obscure, or partially obscure, information presented in display window 110 especially when viewed from a side of (as opposed to the top of) the display window 110. In these instances, the light reflected by the particles may be emitted by the light emitting devices of light-emitting array 120. The light emitting devices of light-emitting array 120 may emit light of a single color (e.g., white or blue) or frequency/wavelength designed to interact with the layer of particles. In some instances, information displayed in display window 110 may appear obscured when it is viewed from certain angles and may appear clear/obscured when viewed from other angles as discussed below with regard to FIGS. 4C and 4D as a result of light reflected from the filter/layer of materials.

Light-emitting array 120 may completely, or partially, surround a perimeter of electronic payment acceptance device 100 and may include a plurality of light emitting devices spaced throughout. The light emitting devices may be configured to emit one or more colors of light (e.g., red, green, yellow, orange, etc.). In some circumstances, the color of the light emitted by the light emitting devices 160 or light-emitting array 120 may be responsive to a process being performed by electronic payment acceptance device 100 as will be discussed in greater detail below. In some cases, a color or pattern of colors of light to be emitted by light-emitting array 120 may be user configurable so that, for example, a user may configure the emitted light to be consistent with a desired color scheme or pattern of colors.

Notch 140 may be an indentation or other adaptation of an edge of electronic payment acceptance device 100 adapted to facilitate insertion and extraction of a card (e.g., a credit card) such as a credit card 155 into electronic payment acceptance device 100 via a slot 150 as shown in FIG. 1C. FIG. 1D shows a credit card 155 inserted into notch 140. The size, shape, and position of notch 140 within electronic payment acceptance device 100 facilitates a users holding of the card to insert into and/or extract the card from notch 140.

Attachment mechanisms 115 may be, for example, screws or other portions of a two-piece attachment mechanism that may be used to, for example, attach the electronic payment acceptance device 100 to a scaffolding, stand, hand-held device, supplementary power source, memory source, strap, handle or combinations thereof. First slot 125 may facilitate insertion of an external memory device (e.g., a secure digital (SD) memory card, smart card or flash drive) (not shown) into and/or extraction of the external memory device from electronic payment acceptance device 100. In some embodiments, first slot 125 is optional and may not be included in all electronic payment acceptance devices 100.

Manual operation buttons 145 may be used to interact with the electronic payment acceptance device 100 in order to, for example, adjust the color or brightness of a display, adjust volume of auditory content provided by the electronic payment acceptance device 100, turn the electronic payment acceptance device 100 on or off, or the like. Ports 135 may be any port, or port type, adapted to connect electronic payment acceptance device 100 to, for example, an external power source, computer, memory, etc. Exemplary ports 135 include, but are not limited to, USB ports, fire wire ports, headphone jacks, USB-C/Thunderbolt 3 ports and the like.

As shown in FIG. 1D, a plurality of light-emitting devices 160 are positioned within a light-emitting array 120, which extends around the entire perimeter/edge of electronic payment acceptance device 100. As shown in FIG. 1D, the light-emitting devices 160 are positioned roughly equidistant from one another so that the amount of light emitted from light-emitting array 120 is approximately uniform throughout. In other embodiments, positioning of light-emitting devices 160 may be concentrated in some areas (e.g., light-emitting devices 160 may be closer together) and less concentrated, or absent from, other areas. For example, light-emitting devices 160 may be concentrated near notch 140 so that, for example, the area of light-emitting array 120 near notch may light up, or change color, to, for example, signal a user to insert his or her credit card.

Additionally, or alternatively, light-emitting devices 160 within light-emitting array 120 may be configured and/or programmed to, for example, change color or alternate color in any pattern in order to, for example, alert a user to perform an action using the electronic payment acceptance device 100 and/or attract a user's (or potential user's) attention. In some cases, changes of color of light-emitting devices 160 may be responsive to motion and/or proximity of a user and/or detection of a user's electronic device (e.g., phone or smart watch) via a near-field communication protocol (e.g., Bluetooth or radio frequency identification (RFID)).

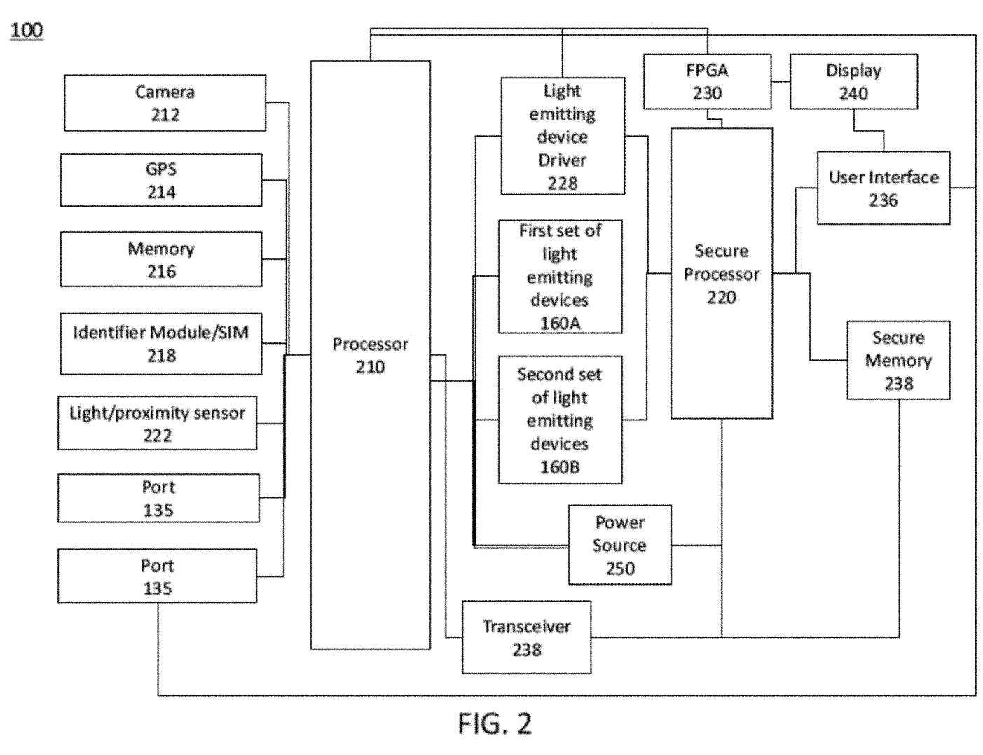

FIG. 2 provides a diagram of an exemplary system diagram for internal components of electronic payment acceptance device 100. Electronic payment acceptance device 100 includes a processor 210, a secure processor 220, an FPGA 230, a display 240, a camera 212, a global positioning system (GPS) device 214, a memory 216, an identifier module/SIM 218, a light and/or proximity sensor 222, two ports 135, a transceiver 238, a light emitting device driver 228, a first set of light emitting devices 160A, a second set of light emitting devices 160B, a power source 250, and a user interface 236.

Camera 212 may be a front, or rear, facing camera. In some embodiments, camera 212 may be configured to capture images in three dimensions. Camera 212 may be used by a user and/or merchant to identify a person or object (e.g., item for sale) using, for example, a 3D rendering process executed by processor 210 and/or secure processor 220.

GPS 214 may be configured to determine a location for electronic payment acceptance device 100. This location may be used by processor 210 and/or secure processor 220 to verify that a particular electronic payment acceptance device 100 (as identified by, for example, identifier module/SIM 218) is in a particular location (e.g., within a store or restaurant). If GPS 214 indicates that the electronic payment acceptance device 100 is not in the particular location, one or more functions or processes (e.g., banking or e-commerce transactions) performed by electronic payment acceptance device 100 may be disabled.

Memory 216 and secure memory 238 may store one or more sets of instructions for execution by a component of electronic payment acceptance device 100 (e.g., processor 210, secure processor 220, transceiver 238, etc.). In addition, secure memory 238 may store instructions regarding execution of secure transactions by secure processor and/or information (e.g., user name, password, an identifier of a mobile phone associated with user) regarding known users and/or user accounts.

Identifier module/SIM 218 may be configured to uniquely identify a particular electronic payment acceptance device 100. Light/proximity sensor 222 may be configured to detect motion, light, and/or a proximity of a device emitting a signal (e.g., a mobile phone or RFID tag). For example, if a change in light proximate to the electronic payment acceptance device 100 and/or a user's or potential user's mobile device is detected, this information may be provided to processor 210 and then processor 210 may transition electronic payment acceptance device 110 from a rest, or sleep, state to an awake state. When a user's or potential user's mobile device is detected, this information may be provided to processor 210 and/or secure processor 220 so that, for example, a user's account, which may be associated with an identifier of the user's mobile device, may be extracted from, for example, secure memory 238 by secure processor 220 so that, for example, a GUI provided to the user via display 240 is populated with a personalized greeting, targeted advertisement, or the like.

Port 135 may be any port via which information may be communicated to, or from, electronic payment acceptance device 110. Although only two ports 135 are shown in FIG. 2, any number (e.g., 3, 4, 8, 10) of ports may be included in electronic payment acceptance device 100. In some instances, transceiver 238 may be configured to also act as a port via wireless communication which will facilitate interaction of electronic payment acceptance device 100 with one or more communication networks (e.g., the Internet) in order to, for example, download one or more software applications, or sets of instructions, for execution by processor 210 and/or secure processor 220. In some instances, processor 210 and/or secure processor 220 may require pre-approval for a software application prior to its communication to and/or storage on electronic payment acceptance device 100. In some instances, pre-approval for a software application may take the form of a digital signature. The digital signature may be associated with, for example, a manufacturer and/or user (e.g., a merchant) of electronic payment acceptance device 100.

In the embodiment of FIG. 2, electronic payment acceptance device 100 has a first set of light emitting devices 160A and a second set of light emitting devices 160B. First set of light emitting devices 160A may be any type of light emitting device and, in some embodiments may be a plurality of multi-colored LEDs. In some circumstances, the light emitting devices of the first set of light emitting devices 160A may not include light emitting devices that may interact with the filter or layer of material discussed above that is responsive to light and partially obscures a GUI provided by display 240. First set of light emitting devices 160A may be coupled to processor 210 and light emitting device driver 228 may receive instructions (e.g., color, brightness, patterns of colors, etc.) therefrom regarding when and how to emit light. Light emitting device driver 228 may also instruct first set of light emitting devices 160A to turn on or off.

Second set of light emitting devices 160B may be coupled to secure processor 220 and light emitting device driver 228 may receive instructions (e.g., brightness, duration, patterns of colors, etc.) therefrom regarding when and how to emit light. Light emitting device driver 228 and/or secure processor 220 may also instruct second set of light emitting devices 160B to turn on or off. In some instances, light emitting devices included within second set of light emitting devices 160B may be configured to emit light of a specific frequency/wavelength or range of frequencies/wavelengths that is configured, or selected, to cooperate with the filter or layer of material discussed above that is responsive to light provided by second set of light emitting devices 160B so as to obscure, or partially obscure, a portion of a GUI provided by display 240.

In many instances, first and second set of light emitting devices 160A and 160B may both reside in a single light-emitting array 120 positioned around a portion, or a totality of, for example, an edge of electronic payment acceptance device 100 and/or an edge of a display window such as display window 110. In other instances, first and second set of light emitting devices 160A and 160B may reside in separate light-emitting arrays. In these instances, first set of light emitting devices 160A may be positioned around an outside edge of electronic payment acceptance device 100 and second set of light emitting devices 160B may be positioned around an outside edge of display window such as display window 110.

User interface 236 may be any user interface (e.g., microphone, keypad, touchscreen) via which a user may interact with electronic payment acceptance device 100. In some embodiments, user interface 236 may be external to electronic payment acceptance device 100 and coupled to electronic payment acceptance device 100 via one or more ports 135. Additionally, or alternatively, user interface 236 may be provided via display 240 as, for example, a keyboard that is responsive to touch.

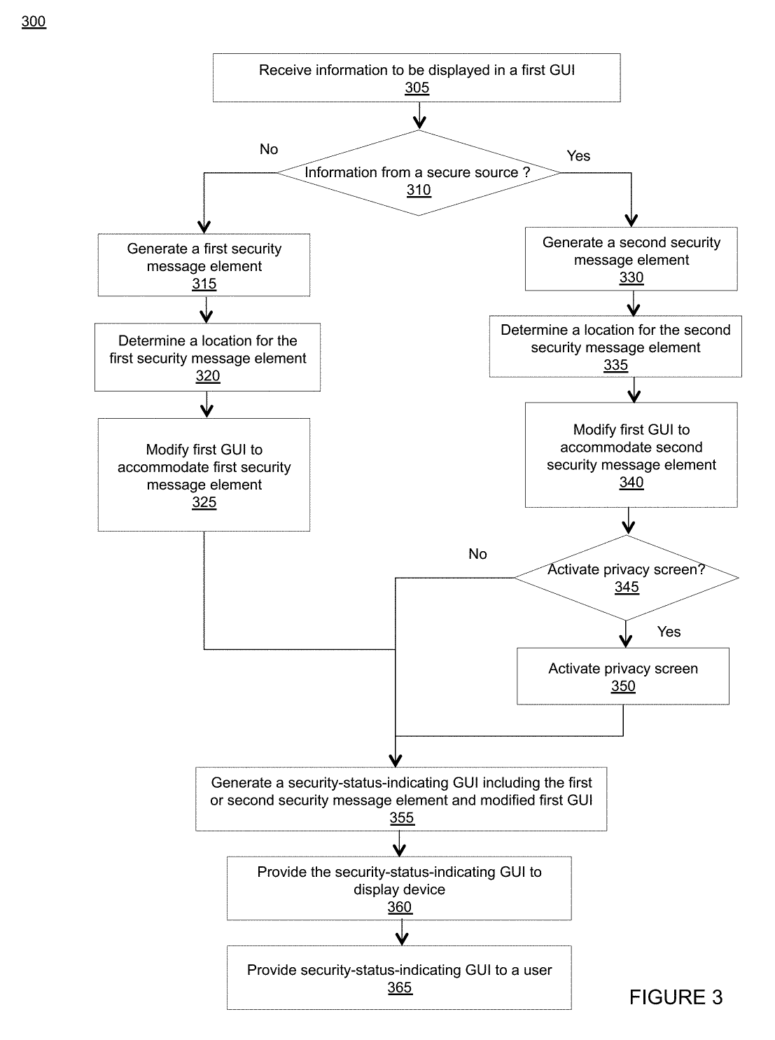

FIG. 3 illustrates an exemplary process 300 for providing a GUI and a security message to a display device such as display window 110. Process 300 may be executed by, for example, system 200 and/or components thereof.

Initially, information to be displayed in a first GUI may be received by, for example, FPGA 230 (step 305). It may then be determined whether the information is from a secure source, such as secure processor 220, or an unsecure source, such as processor 210 (step 310). FPGA 230 may perform the determination of step 310. In some instances, the determination of step 310 may include examination of a digital signature associated with the received information and/or a software application supplying the received information.

Exemplary information that is not from a secure source includes information from a Web browser (e.g., Google or Safari) and/or a software application running on, for example, processor 210. When the information received in step 305 is not from a secure source a first security message element (e.g., “do not enter your PIN,” “unsecure,” and/or an icon (e.g., an unlocked padlock) that may illustrate and/or alert a user to be aware that the source of the first GUI is not secure) may be generated (step 315) and a location for the first security message element may be determined (step 320). The location may be determined randomly, pseudo-randomly, or responsively to, for example, a user's/customer's proximity to electronic payment acceptance device 110 and/or a location of the electronic payment acceptance device 110 (e.g., on a stand or in a merchant's hand). Exemplary locations for the first security message include along one or more outside edges of a displayed GUI. In some embodiments, a position or location of a first security message element may change while a security-status-indicating GUI is provided to a user (following execution of step 365 as discussed below).

Additionally, or alternatively, a position or location of a first security message element may change (or not) for each security-status-indicating GUI that is provided to a user in a random or pseudo-random manner. In this way it is difficult to predict where a first security message element may be displayed. Thus, it may be difficult for the first security message to be obscured by, for example, the application of a physical object (e.g., tape or paint) overlaid onto display 110 in an attempt to cover up the first security message element and thereby trick the user into entering their personal information or PIN into an interface that is not secure.

A size first GUI to be generated using the information received in step 305 may then be adjusted to fit the size/shape of display window 110 when the first security message element is also displayed within display window 110 (step 325). In many cases, the adjustment of step 325 includes proportionally reducing the size, or otherwise dynamically updating the size and/or shape of the first GUI so as to, for example, preserve the functionality and/or aesthetics of the first GUI as originally intended. Then, a security-status-indicating GUI including the first security message element and the modified GUI may be generated (step 355) and the security-status-indicating GUI may be provided to a display device such as display device 240 (step 360) for provision to a user (step 365).

FIGS. 4A provides interface 400A showing an exemplary unmodified first GUI 410A that may be displayed via display window 110 by display device 240. GUI 410A occupies the entirety of display window 110. GUI 410A is in its original state as would be received in step 305. Information used to generate GUI 410A may be provided responsively to, for example, an instruction from a software application running on processor 210 and/or an Internet browser search.

FIG. 4B provides an exemplary security-status-indicating GUI 400B showing a first security message element 440 and an exemplary modified version of first GUI 420. First security message element 440 is provided in the form of two rectangular graphic elements arranged in an inverted “L” configuration positioned along the left side and top of security-status-indicating GUI 400B. First security message element 440 may be in any position on interface 400B (e.g., left side only, right side only, top and bottom, etc.) and may be determined via execution of step 320. In many cases, a size, position, and orientation of first security message element 440 may be randomly, or pseudo-randomly generated and/or displayed on interface 400B so that it does not interfere with/overlap modified GUI 420.

FIG. 4B shows how first GUI as shown in FIG. 4A is modified, or proportionally scaled down, to fit within a display window so that first security message element does not overlap with, or otherwise obscure, first GUI 420 (when modified). First security message element 440 provides an indication to the user that electronic payment acceptance device 100 is not operating in a secure mode in the form of an exemplary textual message (in this case, “Do Not Enter Pin”). Content and/or format of first security message element 440 may be determined and/or generated via execution of step 315. Other exemplary security messages include, but are not limited to, graphics (e.g., a circle with a line through it), and icons. In some instances, first security message element 440 may be any size, shape, or color and, in some instances may be a pattern of two or more colors. In some instances, an edge of first security message element 440 may be patterned (e.g., zigzag, curves, etc.).

When information to generate a first GUI is from a secure source (e.g., secure processor 220) (step 310), then a second security message element may be generated (step 330). In some embodiments, the second security message element is similar to the first security message element but includes different text (e.g., “enter your pin” or “secure mode”). In other embodiments, the second security message element may be generated so as to appear different from the first security message element. In some instances, the first and/or second security message element may be accompanied by a sound or recording (e.g., an auditory message reading the content of the first and/or second security message element), animation, and/or images.

In step 335, a location for the second security message element may be determined. Next, the first GUI may be modified (e.g., the size of GUI as displayed on the display window may be proportionally reduced) to accommodate display of the second security message element (step 340). In some embodiments, execution of steps 330, 335, and 340 may resemble execution of steps 315, 320, and 325, respectively except that the content, format, layout, etc. of the second security message element may different from that of the first security message element.

Additionally, or alternatively, a position or location of a second security message element may change (or not) for each security-status-indicating GUI that is provided to a user in a random or pseudo-random manner. In this way it is difficult to predict where a first security message element may be displayed. Thus, it may be difficult for the second security message to be obscured by, for example, the application of a physical object (e.g., tape or paint) overlaid onto display 110.

Optionally, in step 345, it may be determined whether to activate a privacy screen 245 and, if not, process 300 proceeds to step 355. If so, a privacy screen may be activated (step 350). In some instances, activating the privacy screen may include turning on second set of light emitting devices 160B so that light therefrom may interact with a filter or layer of particles thereby obscuring the GUI provided on a display window.

Then, in step 355 a security-status-indicating GUI including the second security message element and the modified first GUI may be generated and provided to the display device (step 360). The display device may then provide the security-status-indicating GUI to the user (step 365).

FIG. 4C provides an exemplary security-status-indicating GUI 400C that includes a second security message element 450 and a modified first GUI 420 as may be generated via execution of steps 330-365. When a privacy screen has been activated, it may only obscure security-status-indicating GUI when viewed at an angle (e.g., 40° or 60° off from a perpendicular bisector through the center of GU 400C) so that it security-status-indicating GUI may be clearly visible by a user standing over an electronic payment acceptance device 100 displaying security-status-indicating GUI (e.g., the user's face is directly above the electronic payment acceptance device 100) but obscured for an onlooker positioned at an angle to the electronic payment acceptance device 100. In this way, a person standing next to a user may not be able to see either the security-status-indicating GUI or the user's interaction with the security-status-indicating GUI (e.g., entering of a PIN number). Thus, a user standing above electronic payment acceptance device 100 may view security-status-indicating GUI 400C as shown in FIG. 4C whether or not the privacy screen has been activated in step 350.

FIG. 4D provides an example of an interface 400D that shows an activated privacy screen 450 that may obscure security-status-indicating GUI 400C from an onlooker (i.e., not the user) who is trying to view security-status-indicating GUI 400C from an angle or the side of electronic payment acceptance device 100.

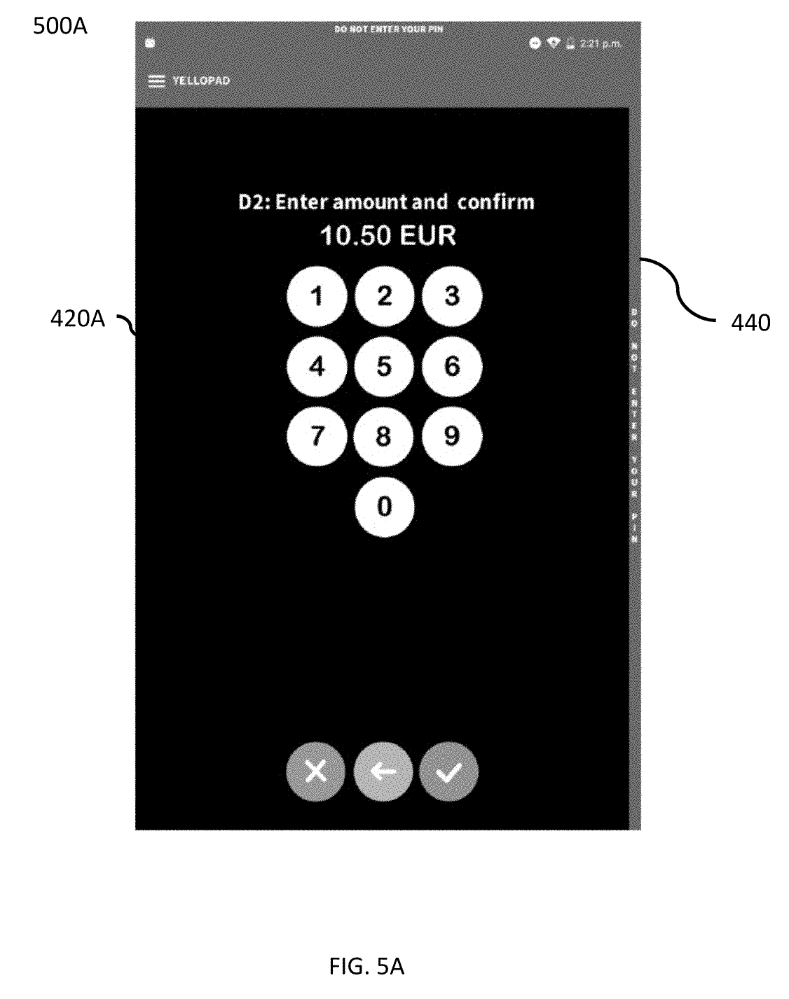

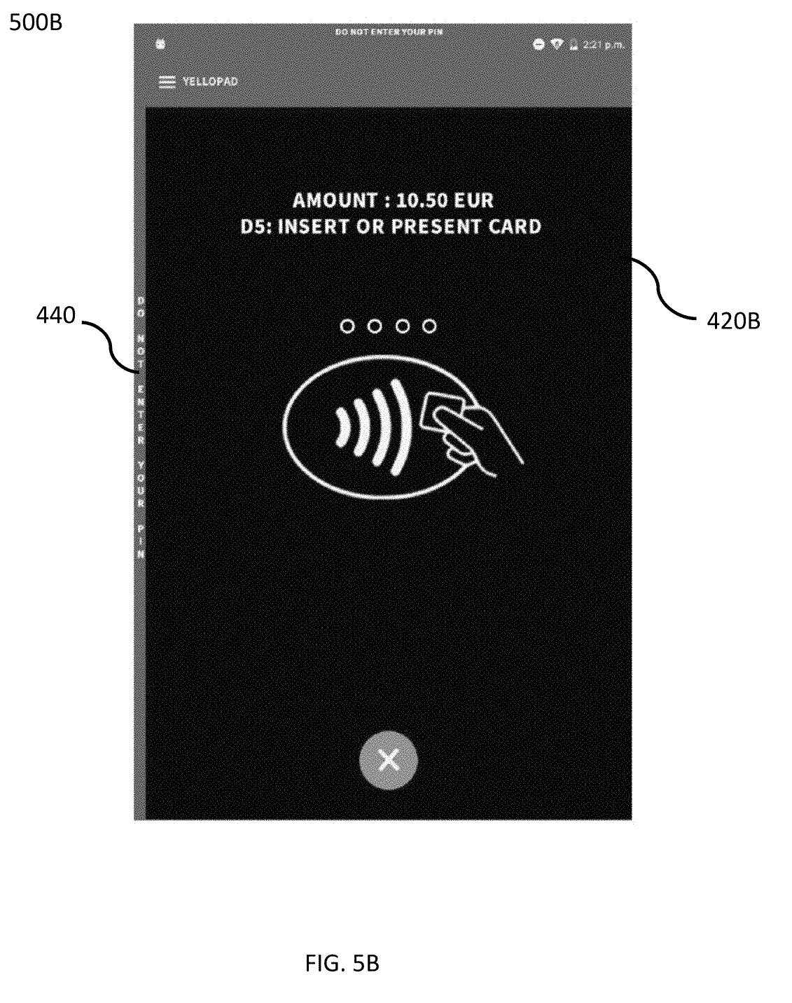

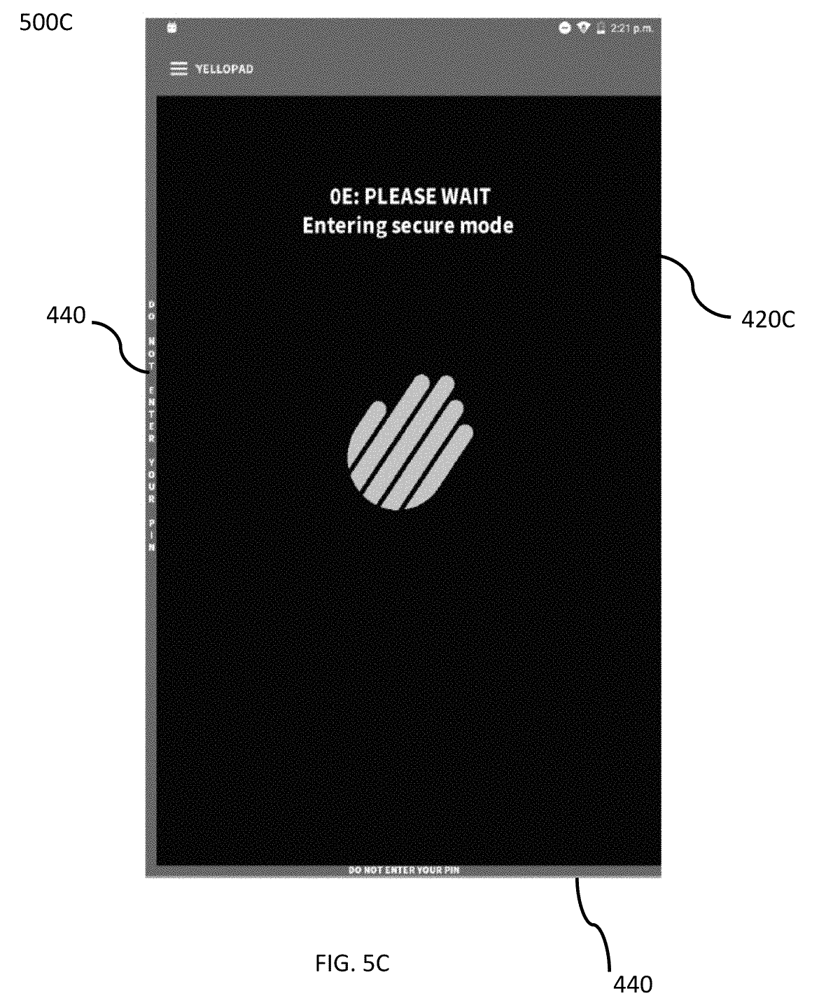

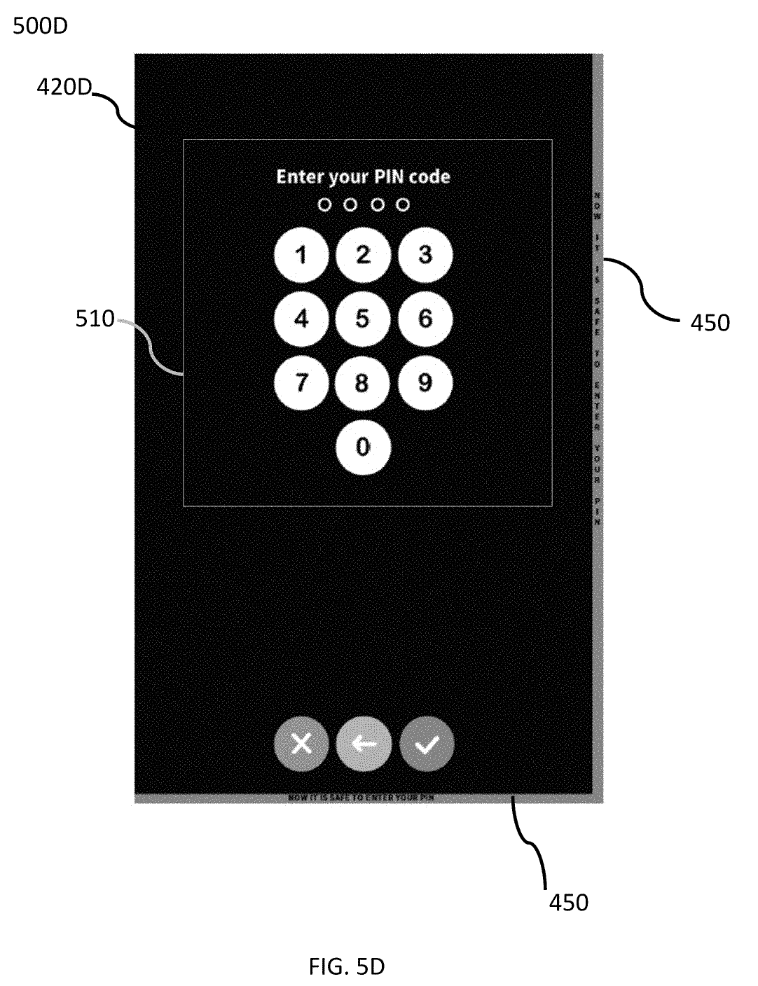

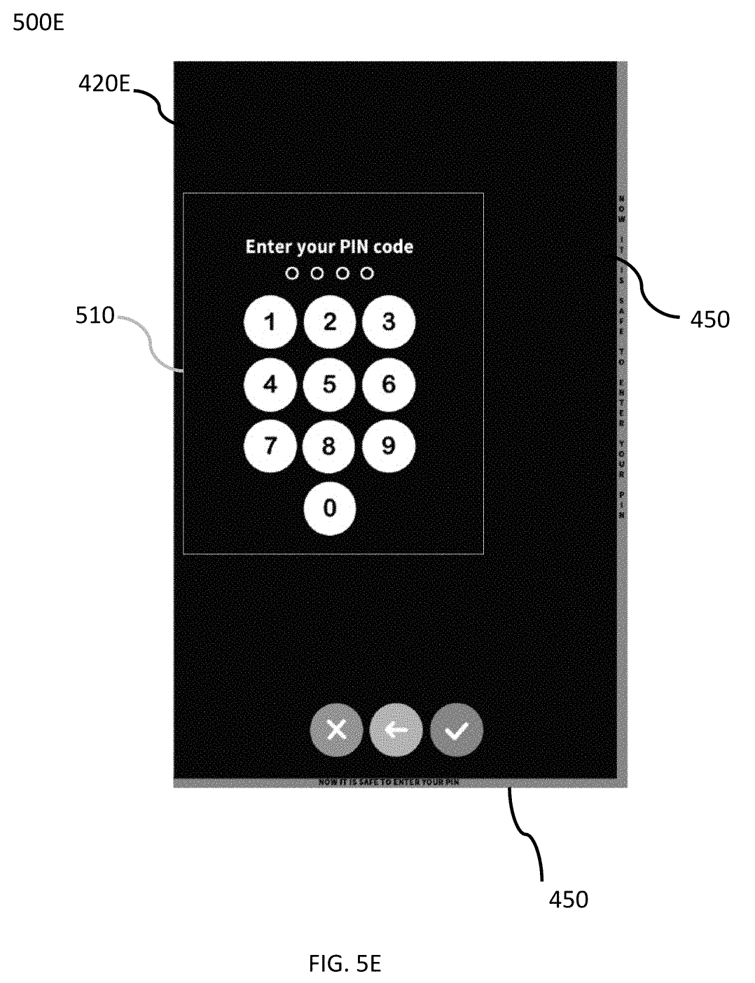

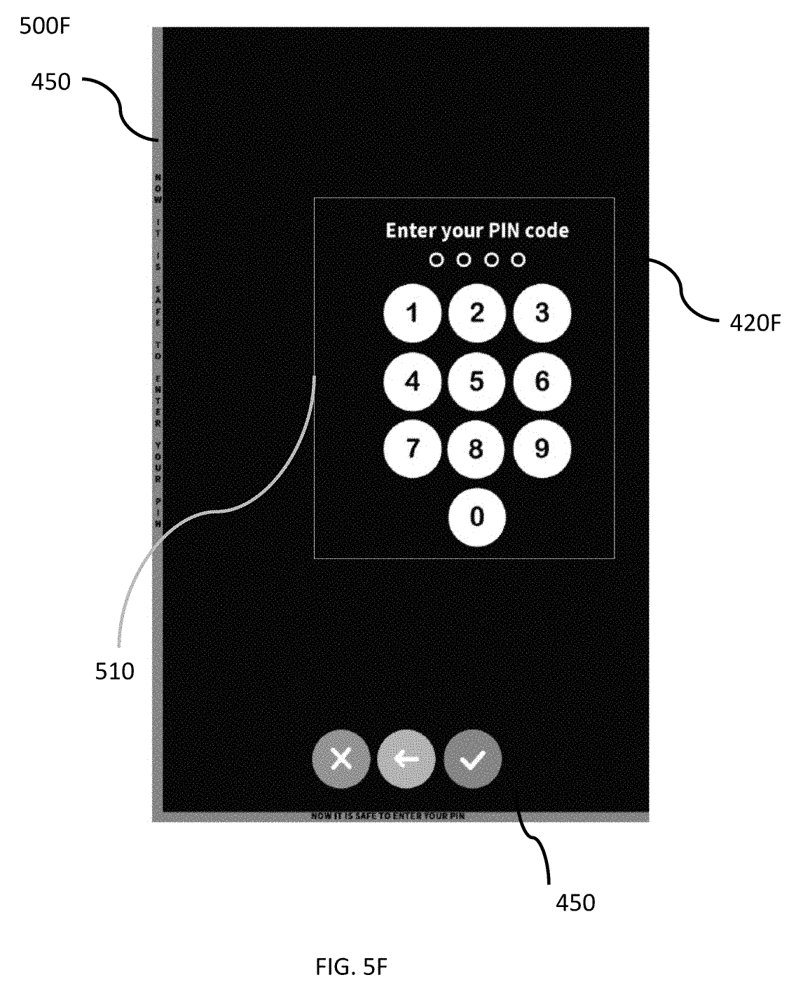

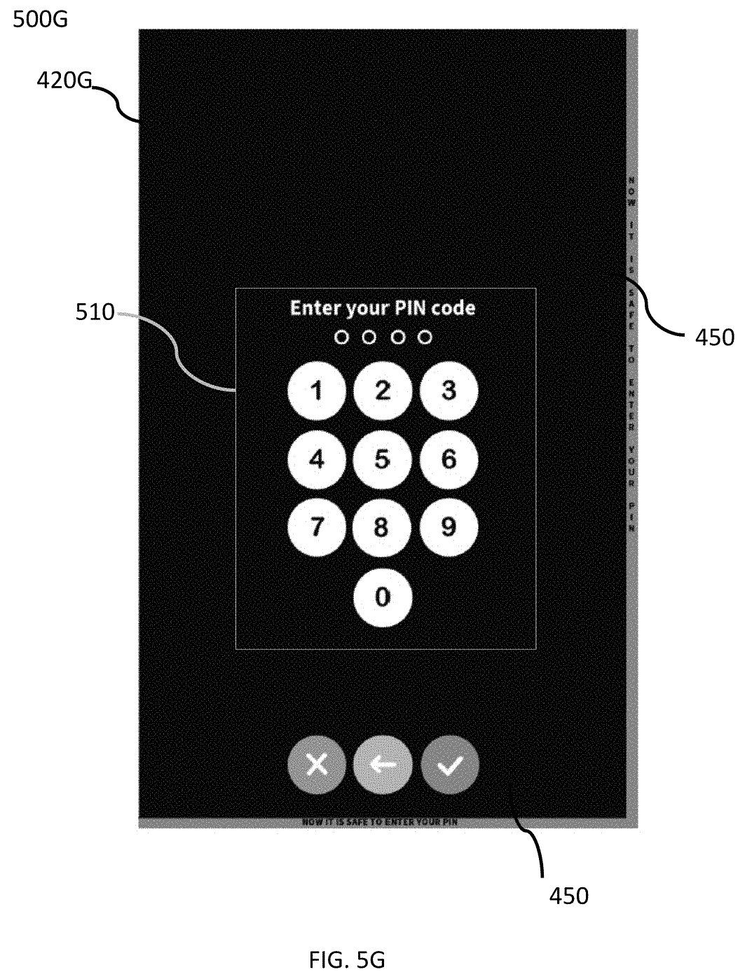

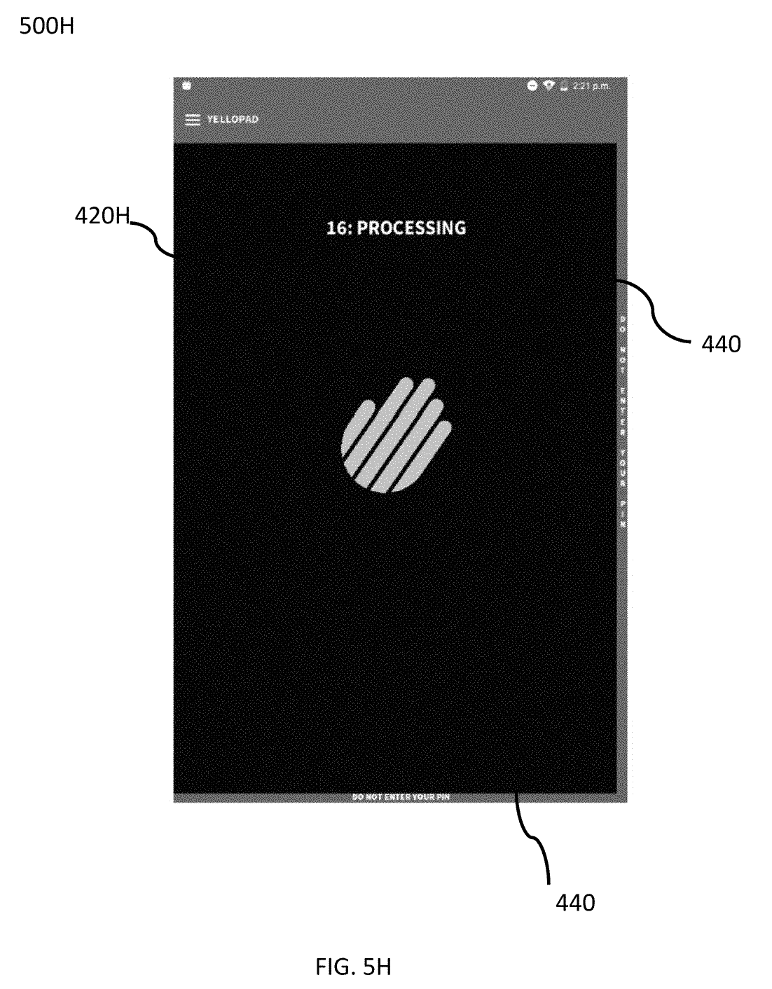

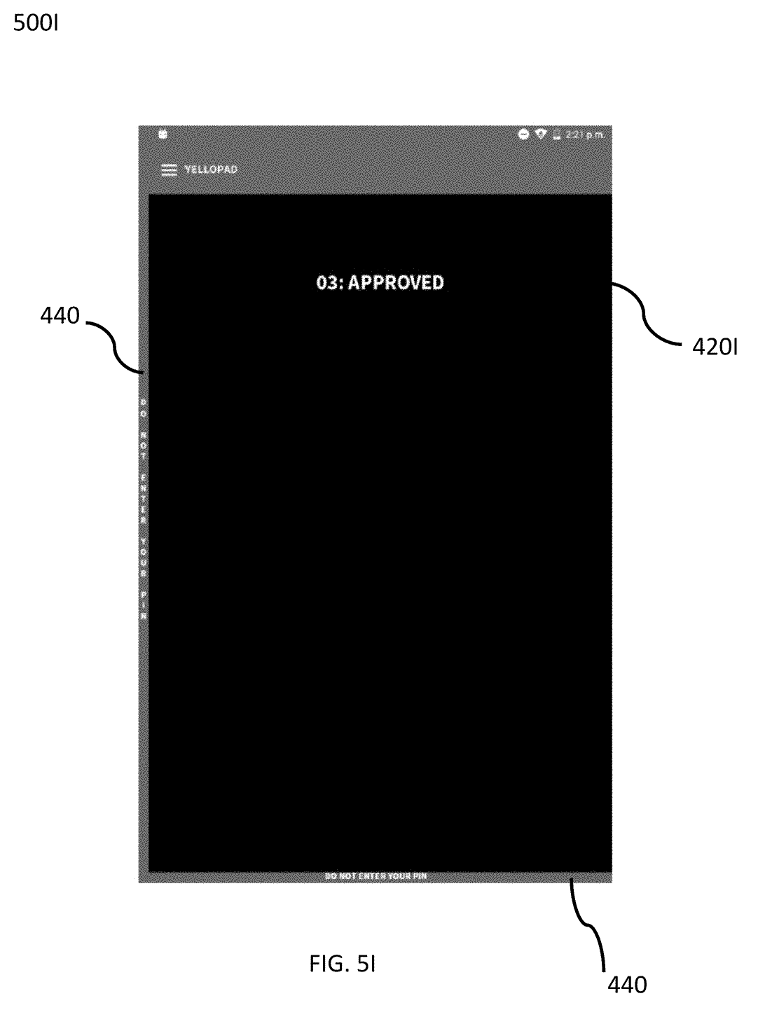

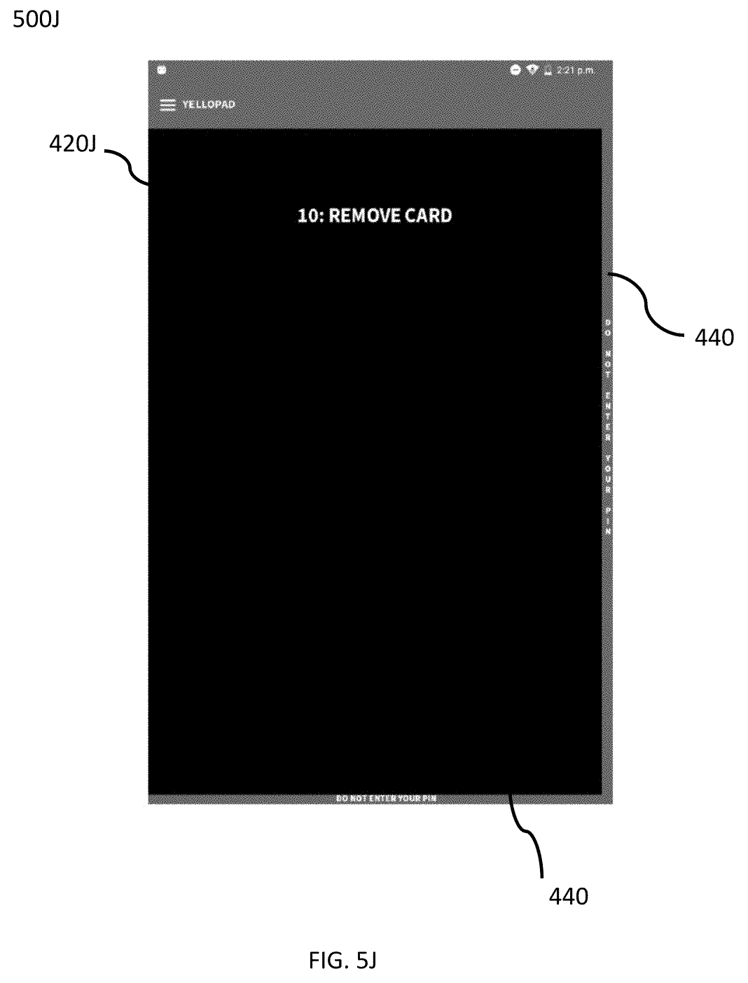

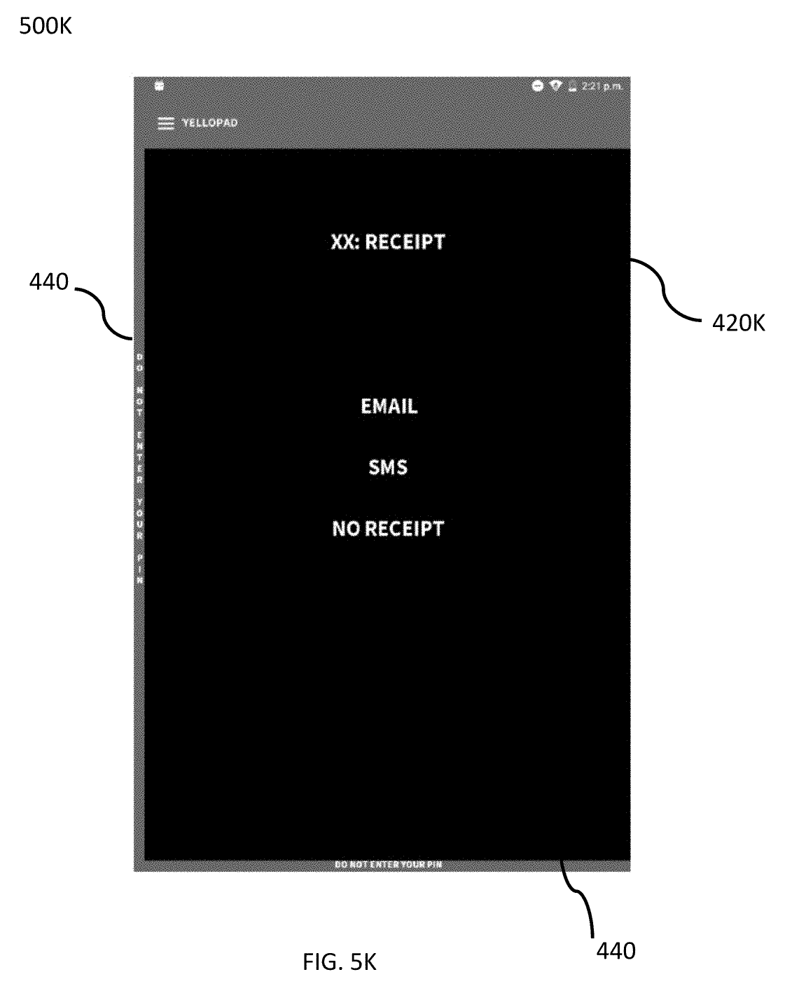

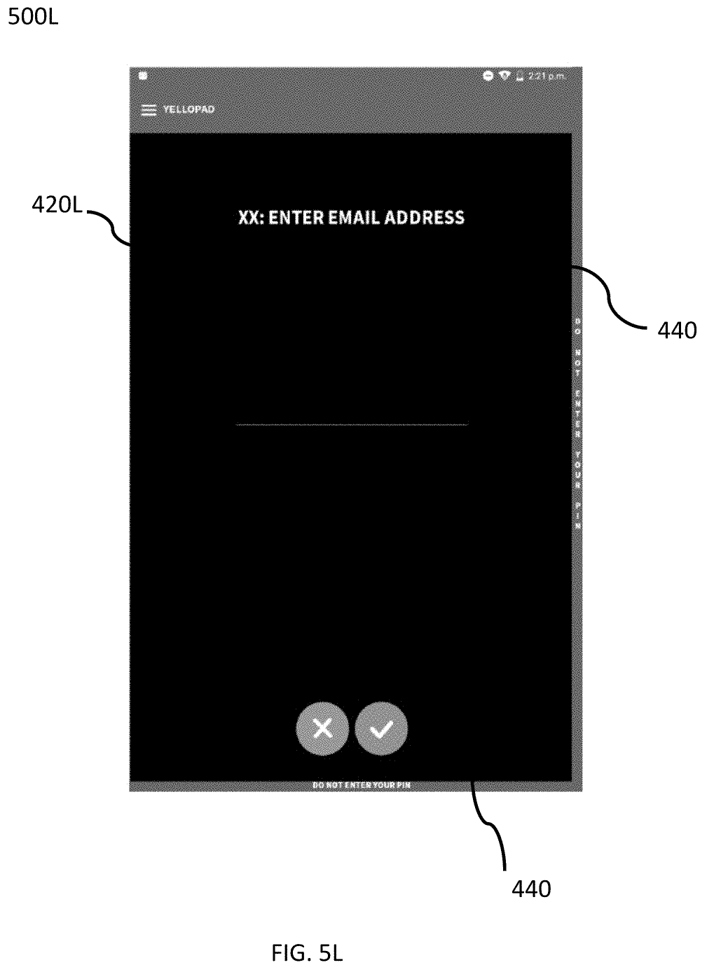

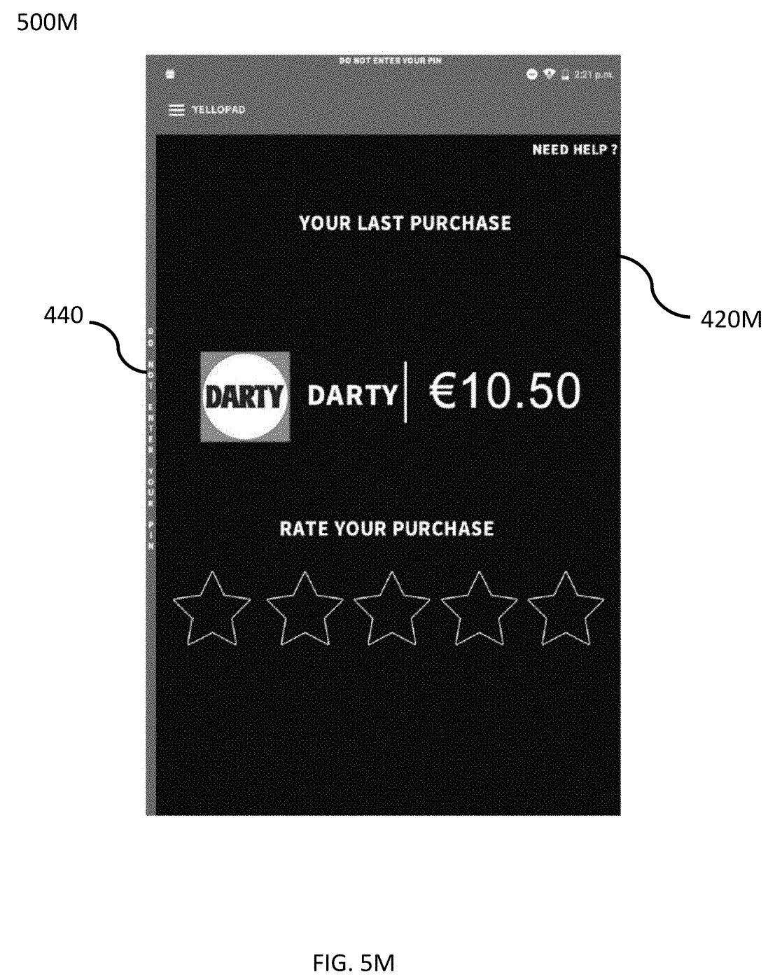

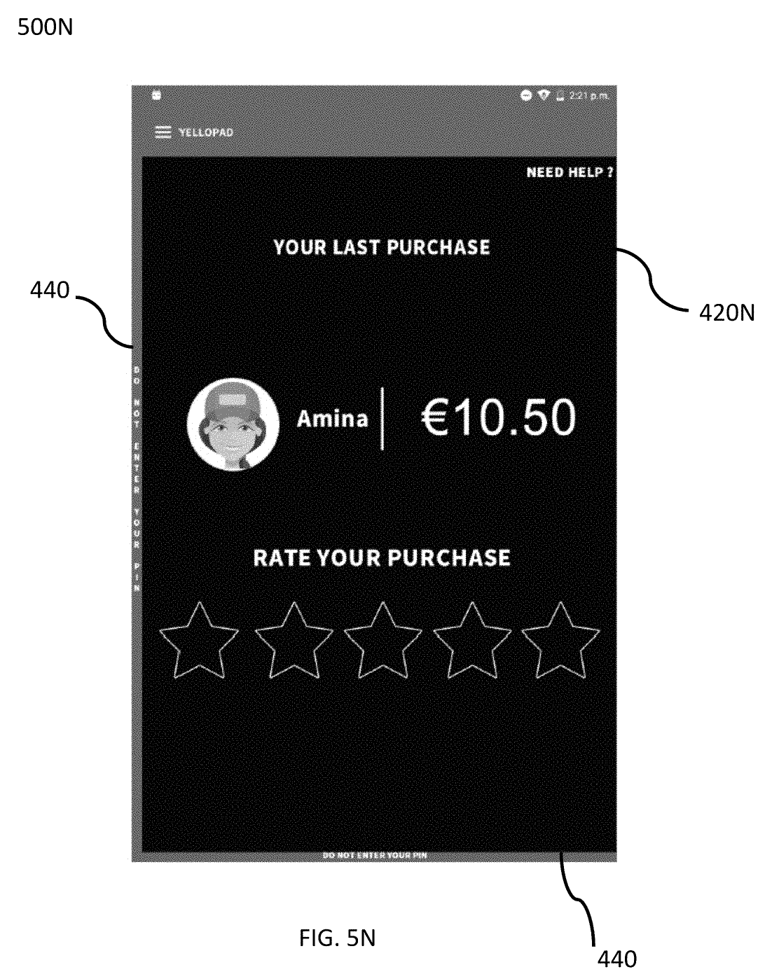

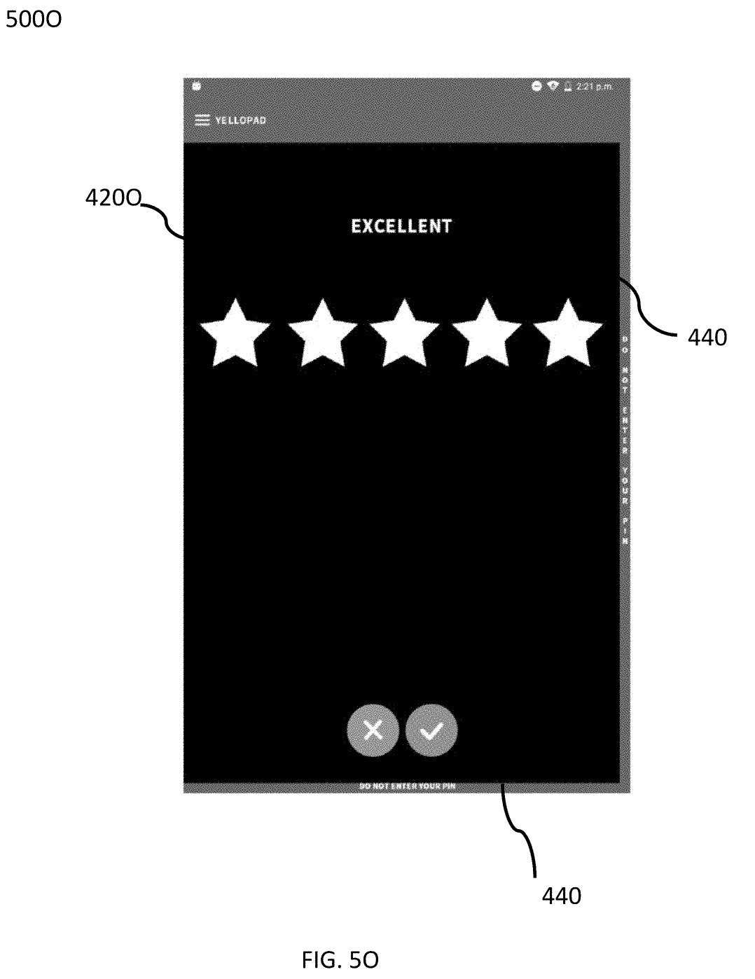

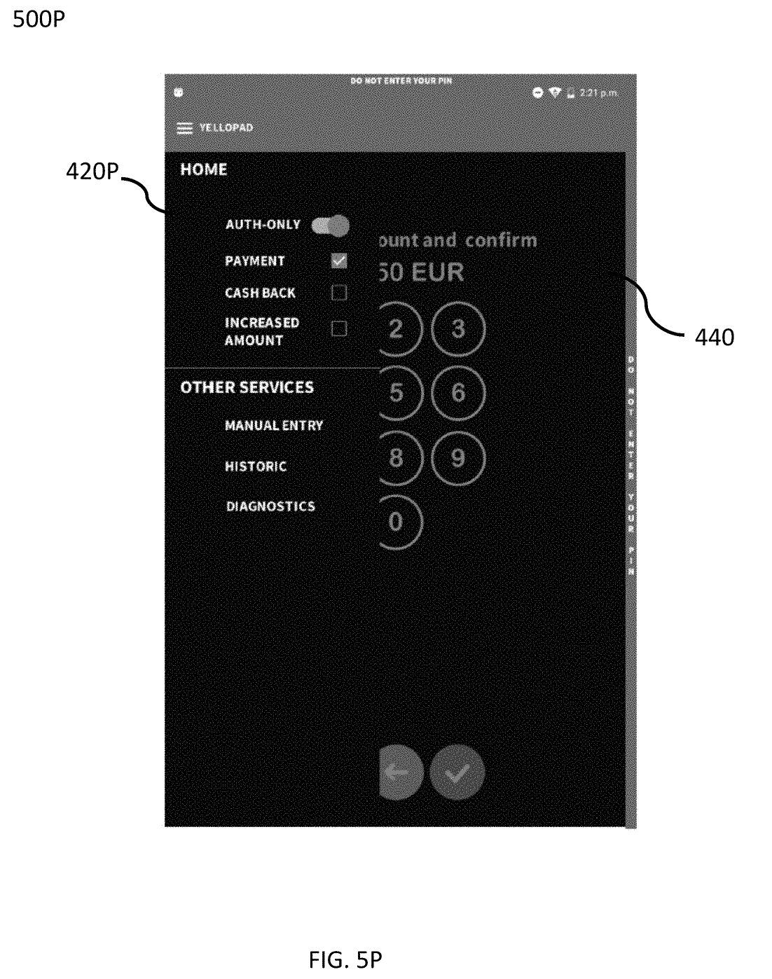

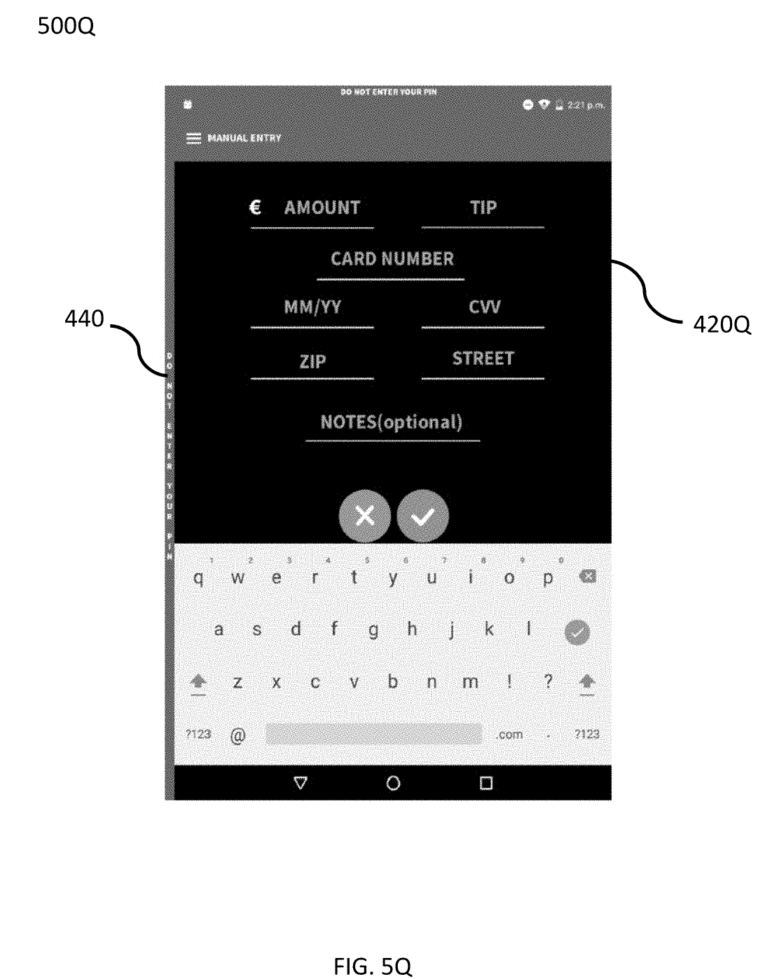

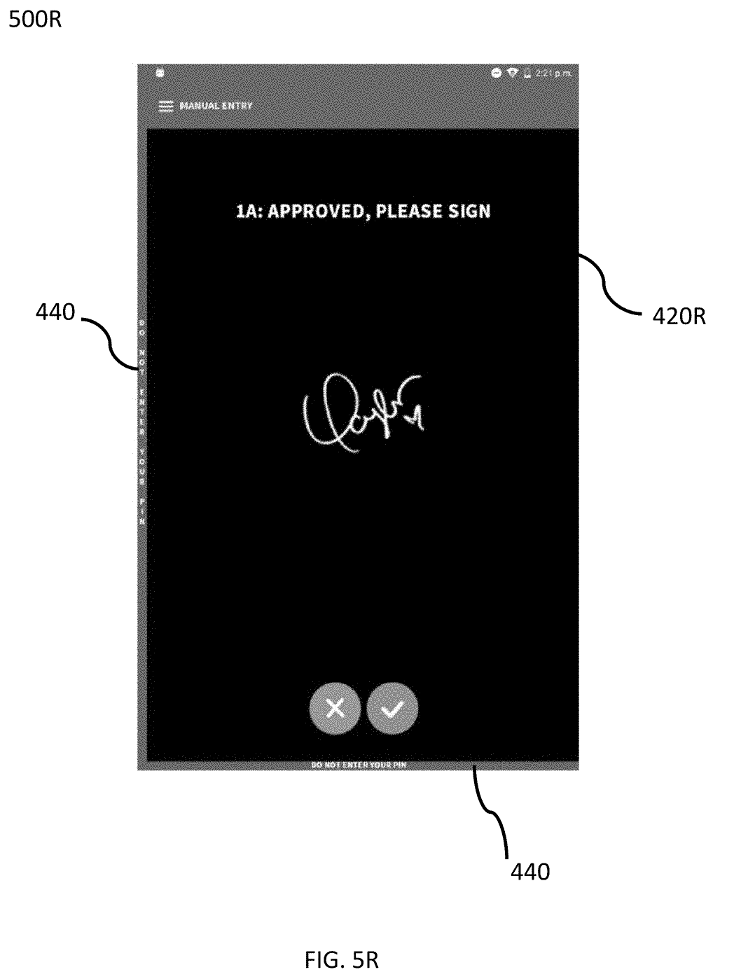

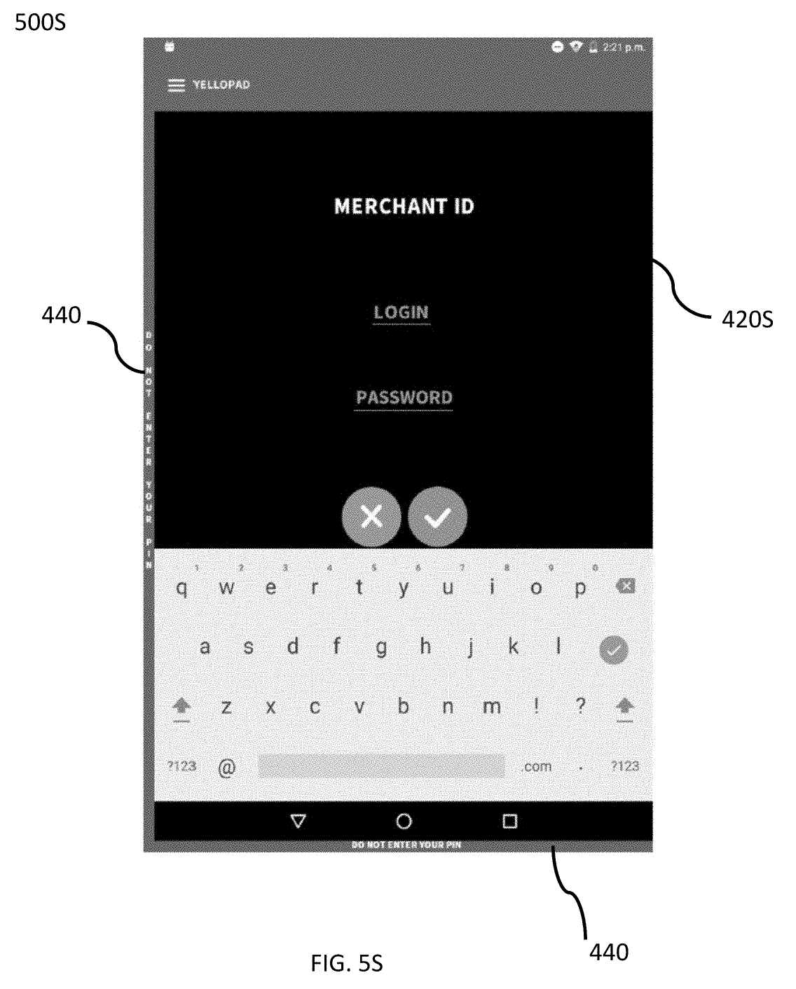

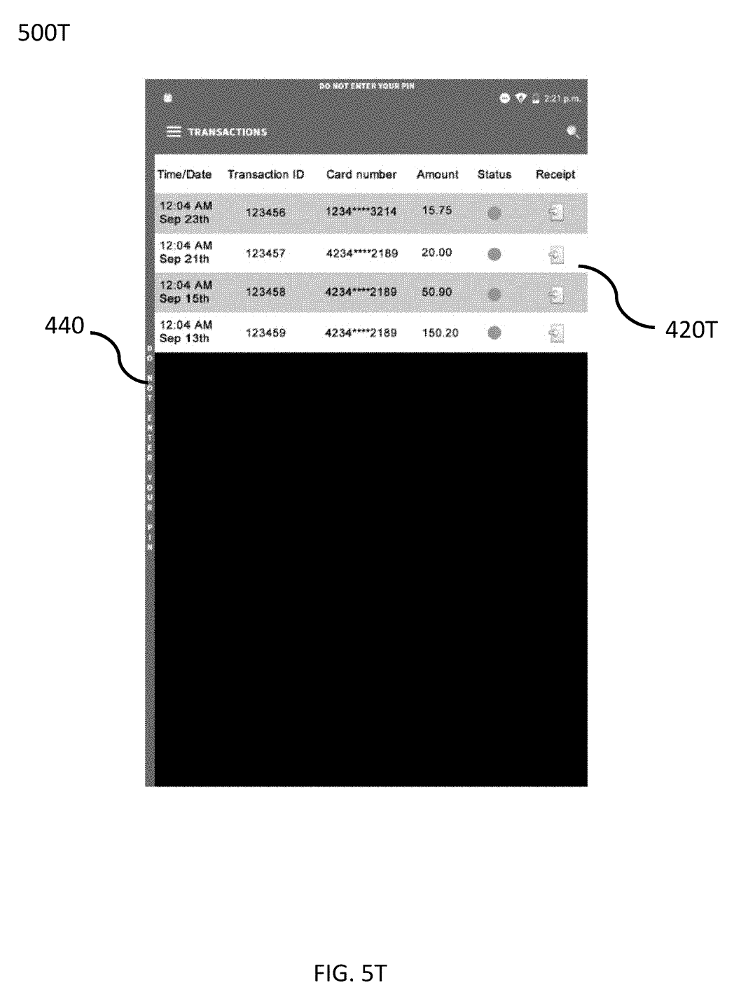

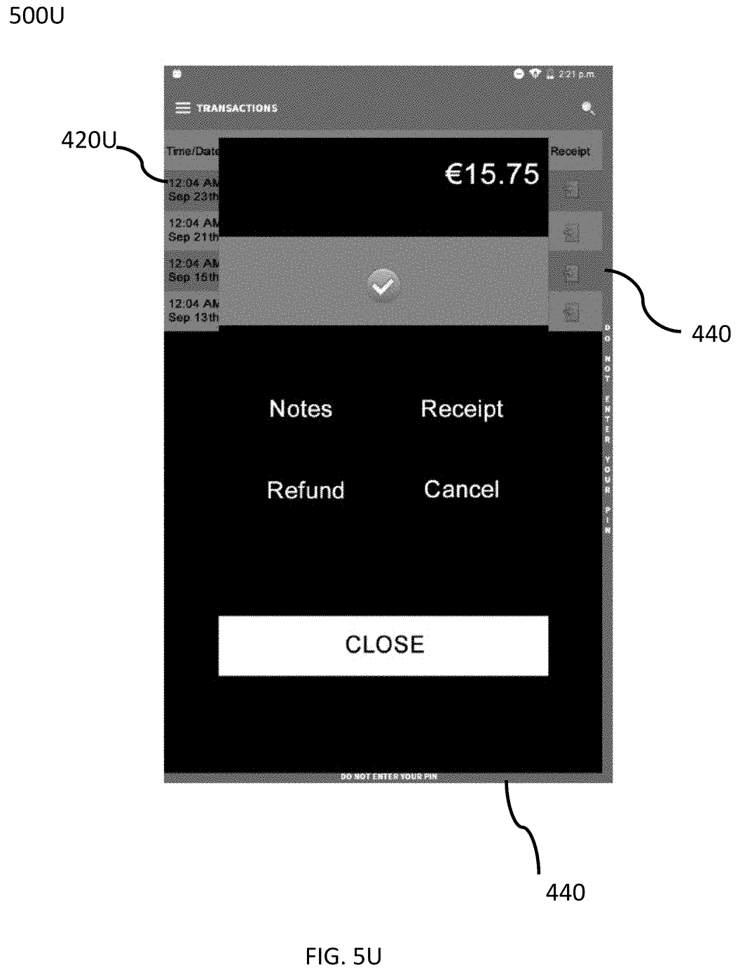

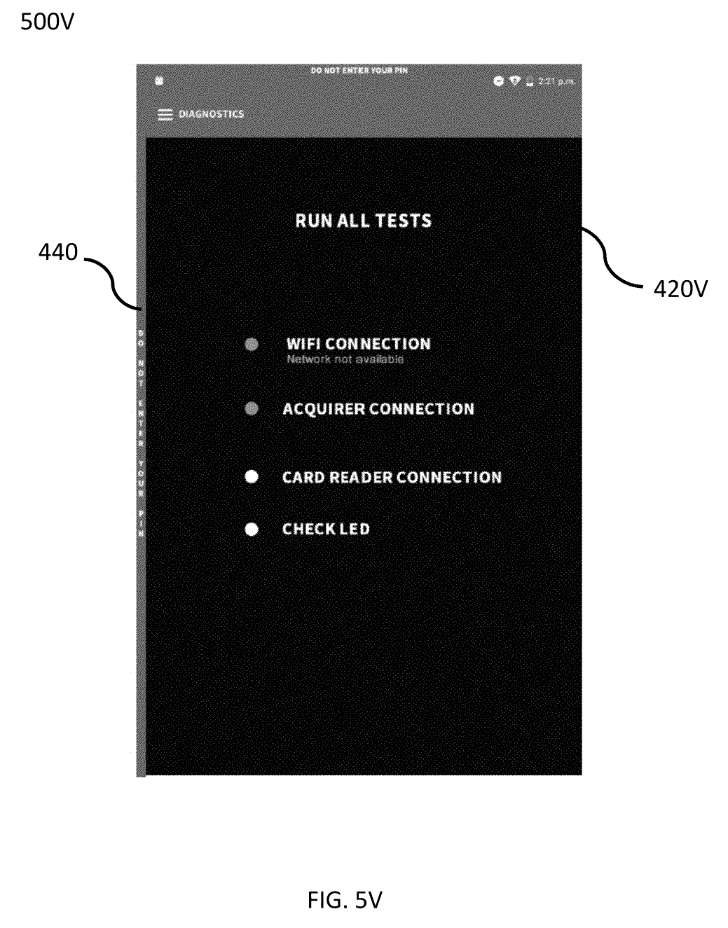

FIGS. 5A-5V provide a series of security-status-indicating GUIs 500A-500V that show a series of security-status-indicating GUIs that may be provided via display window 110 during various steps of a commercial/financial transaction using, for example, the user's payment information (e.g., credit card or bank account information). GUIs 500A-500V may be provided to a user following execution of process 300, or a portion thereof.

Initially, in FIG. 5A, an exemplary security-status-indicating GUI 500A by which a merchant (or user) may enter an amount of a financial transaction may be provided to a user. GUI 500A includes a first security message element 440 appearing as a rectangular graphic element positioned on a right side of modified version of first GUI 420A. First security message element 440 provides an indication to the user that electronic payment acceptance device 100 is not operating in a secure mode in the form of an exemplary textual message (in this case, “Do Not Enter Your Pin”). Modified GUI 420A provides a message (Enter amount and confirm) along with user interface elements in the form of numbers and symbols that the user may select in order to enter the amount of a transaction.

Security-status-indicating GUI 500B of FIG. 5B shows a next step in the transaction whereby the amount entered into security-status-indicating GUI 500A is presented in modified version of first GUI 420B along with an instruction to insert or present a payment method (in this case, a credit card). Security-status-indicating GUI 500B also shows first security message element 440 appearing as a rectangular graphic element positioned on a left side of modified version of first GUI 420B.

Security-status-indicating GUI 500C of FIG. 5C shows a next step in the transaction whereby a message indicating that electronic payment acceptance device 100 is entering a secure mode is presented in modified version of first GUI 420BC. Security-status-indicating GUI 500C also shows first security message element 440 appearing as rectangular graphic elements positioned on the left and bottom sides of modified version of first GUI 420C.

Security-status-indicating GUI 500D of FIG. 5D shows a next step in the transaction whereby a PIN entry graphic element 510 is presented in modified version of first GUI 420BD. Security-status-indicating GUI 500C also shows second security message element 450 appearing as rectangular graphic elements positioned on the right and bottom sides of modified version of first GUI 420D. Second security message element 450 includes the message “now it is safe to enter your PIN.” A position of PIN entry graphic element 510 within modified version of first GUI 420D may be randomly determined. Random placement of PIN entry graphic element 510 may serve to thwart efforts to observe a user's entry of his or her PIN or determine the user's PIN after it has been entered by, for example, examining a smudge print produced by the user's touching of the display window 110 proximate to the interface elements of PIN entry graphic element 510.

Examples of different randomly determined positions for PIN entry graphic element 510 are provided by security-status-indicating GUIs 500E-550G as shown in FIGS. 5E-5G, respectively. For instance, security-status-indicating GUI 500D of FIG. 5D shows the position of PIN entry graphic element 510 as centered along a vertical midline and a majority of PIN entry graphic element 510 above a horizontal midline. Security-status-indicating GUI 500E of FIG. 5E shows the position of PIN entry graphic element 510 as positioned to the left and lower than the PIN entry graphic element 510 of security-status-indicating GUI 500D. Security-status-indicating GUI 500F of FIG. 5F shows the position of PIN entry graphic element 510 as positioned to the right and lower than the PIN entry graphic element 510 of security-status-indicating GUI 500D. Security-status-indicating GUI 500G of FIG. 5G shows the position of PIN entry graphic element 510 as positioned as centered along the Y-axis and lower than the PIN entry graphic element 510 of security-status-indicating GUI 500D. It will be understood by those of skill in the art that although only four different positions for PIN entry graphic element 510 are shown via FIGS. 5D-5G, any number of different positions for PIN entry graphic element 510 are contemplated by the present invention. Additionally, or alternatively, an orientation of PIN entry graphic element 510 may be randomly selected so that, for example, PIN entry graphic element 510 is rotated by, for example, 10° or 20°. It will also be appreciated that although security-status-indicating GUIs 500D-500G provides an array of a graphic elements corresponding to Arabic numerals, a security-status-indicating GUI may be adapted to provide any type of graphic element (e.g., picture, icon, security question, etc.) by which a user may enter his or her personally identifying information.

After a PIN has been entered into security-status-indicating GUIs 500D-500G, electronic payment acceptance device 100 may process the entered information in order to, for example, verify the user's identity and/or financial information. Often times, electronic payment acceptance device 100 will enter an unsecure mode following entry of the PIN. Security-status-indicating GUI 500H of FIG. 5H provides an example of a modified version of first GUI 420H that provides a message indicating that the electronic payment acceptance device 100 is processing the received information. Security-status-indicating GUI 500H also shows first security message element 440 appearing as rectangular graphic elements positioned on the right and bottom sides of modified version of first GUI 420H.

Security-status-indicating GUI 500I of FIG. 5I provides an example of a modified version of first GUI 420I that provides a message indicating that the electronic payment acceptance device 100 has approved the financial transaction. Security-status-indicating GUI 500I also shows first security message element 440 appearing as rectangular graphic elements positioned on the left and bottom sides of modified version of first GUI 420I.

Security-status-indicating GUI 500J of FIG. 5J provides an example of a modified version of first GUI 420J that provides a message requesting that the user remove his or her card. Security-status-indicating GUI 500J also shows first security message element 440 appearing as rectangular graphic elements positioned on the right and bottom sides of modified version of first GUI 420J.

Security-status-indicating GUI 500K of FIG. 5K provides an example of a modified version of first GUI 420K that provides a message requesting that the user select a preference for receiving a receipt for the transaction. Security-status-indicating GUI 500K also shows first security message element 440 appearing as rectangular graphic elements positioned on the left and bottom sides of modified version of first GUI 420K.

Security-status-indicating GUI 500L of FIG. 5L provides an example of a modified version of first GUI 420L that provides a message requesting that the user enter an email address for receiving a receipt for the transaction. Security-status-indicating GUI 500L may be displayed responsively to a user's selection that he or she would like to receive a receipt via email using security-status-indicating GUI 500K. Security-status-indicating GUI 500L also shows first security message element 440 appearing as rectangular graphic elements positioned on the left and bottom sides of modified version of first GUI 420L.

Security-status-indicating GUI 500M of FIG. 5M provides an example of a modified version of first GUI 420M that provides an opportunity for the user to rate the quality of his or her purchase as it relates to the transaction. Security-status-indicating GUI 500M also shows first security message element 440 appearing as rectangular graphic elements positioned on the left side of modified version of first GUI 420M.

Security-status-indicating GUI 500N of FIG. 5N provides an example of a modified version of first GUI 420N that provides an opportunity for the user to rate the quality of a salesperson that assisted the user with the transaction. Security-status-indicating GUI 500N also shows first security message element 440 appearing as rectangular graphic elements positioned on the left and bottom sides of modified version of first GUI 420N.

Security-status-indicating GUI 500O of FIG. 50 provides an example of a modified version of first GUI 420O that provides a message indicating the user's rating of the purchase and/or salesperson associated with the transaction. Security-status-indicating GUI 500O also shows first security message element 440 appearing as rectangular graphic elements positioned on the right and bottom sides of modified version of first GUI 420O.

Security-status-indicating GUI 500P of FIG. 5P provides an example of a modified version of first GUI 420P that provides a menu of options by which a user and/or merchant may interact with electronic payment acceptance device 100 and/or advance to a different GUI/screen. Security-status-indicating GUI 500P also shows first security message element 440 appearing as rectangular graphic elements positioned on the right side of modified version of first GUI 420P.

Security-status-indicating GUI 500Q of FIG. 5Q provides an example of a modified version of first GUI 420Q that provides a series of prompts requesting information for a user's credit card along with graphic element providing a keyboard whereby the user and/or merchant may enter the user's credit card information. Security-status-indicating GUI 500Q may be displayed responsively to, for example, an error reading the user's credit card or an absence of the physical credit card (e.g., via a phone order). Security-status-indicating GUI 500Q also shows first security message element 440 appearing as rectangular graphic elements positioned on the left side of modified version of first GUI 420Q.

Security-status-indicating GUI 500R of FIG. 5R provides an example of a modified version of first GUI 420R that provides a message indicating the transaction has been approved and requesting the user's signature. Security-status-indicating GUI 500R also shows first security message element 440 appearing as rectangular graphic elements positioned on the left and bottom sides of modified version of first GUI 420R.

Security-status-indicating GUI 500S of FIG. 5S provides an example of a modified version of first GUI 420S that provides a series of prompts requesting information regarding a merchant identification (ID) whereby the merchant may enter the his or her identification information. Security-status-indicating GUI 500S also shows first security message element 440 appearing as rectangular graphic elements positioned on the left and bottom sides of modified version of first GUI 420S.

Upon verification of the merchant ID, the merchant may be able to access further GUIs that provide information about transactions that have occurred on, for example, the electronic payment acceptance device 100 and/or other electronic payment acceptance devices 100 or transaction terminals associated with the merchant. For example, security-status-indicating GUI 500T of FIG. 5T provides an exemplary list of transactions along with date, time, transaction ID, partially redacted credit card information, transaction amount, transaction status, and an icon, the selection of which will provide a display of a receipt associated with a transaction. Security-status-indicating GUI 500T also shows first security message element 440 appearing as rectangular graphic elements positioned on the left side of modified version of first GUI 420T.

Security-status-indicating GUI 500U of FIG. 5U provides exemplary information pertaining to a transaction (e.g., a transaction provided by the list of transactions of modified version of first GUI 420T). Security-status-indicating GUI 500U also shows first security message element 440 appearing as rectangular graphic elements positioned on the right and bottom sides of modified version of first GUI 420U.

Security-status-indicating GUI 500U of FIG. 5U provides exemplary information pertaining to a transaction. Security-status-indicating GUI 500U also shows first security message element 440 appearing as rectangular graphic elements positioned on the right and bottom sides of modified version of first GUI 420U.

Security-status-indicating GUI 500V of FIG. 5V provides exemplary information pertaining tests that may be run to determine the functionality of various components of electronic payment acceptance device 100. Security-status-indicating GUI 500V also shows first security message element 440 appearing as rectangular graphic elements positioned on the right side of modified version of first GUI 420V.

The following discussion provides a few examples of how an electronic payment acceptance device 100 may be used by various merchants in a few exemplary circumstances. In a first exemplary scenario, an electronic payment acceptance device 100 may be proximate to a table, or other eating area, in a restaurant. Light-emitting array 120 may be emitting light of a particular color or range of colors. Display window 110 may provide a security-status-indicating GUI displaying a welcome message and/or an advertisement along with a first security message element. The advertisement may be related to the restaurant (e.g., advertising a daily special) or a general advertisement as may be offered by, for example, a television network or content provision platform. When a patron of the restaurant (or an electronic device, like a mobile phone) approaches the electronic payment acceptance device 100 or otherwise interacts with it, a security-status-indicating GUI providing a first security message element and a menu for the restaurant may be displayed and the patron may place his or her order via interacting with the GUI. Additionally, or alternatively, light emitted by light-emitting array 120 may change upon interaction with the patron. The patron may then be asked to enter payment information via a security-status-indicating GUI provided on display window 110. Light emitted by light-emitting array 120 may change to indicate to the patron that he or she is required to enter payment information. With these interactions, the patron may order and pay for his or her food. Additionally, or alternatively, the patron may use electronic payment acceptance device 100 to interact with staff of the restaurant in order to, for example, request additional food items or a drink of water. In some instances, the electronic payment acceptance device 100 may provide the user with one or more security-status-indicating GUIs, by which he or she may rate his or her experience with the restaurant, interact with a user account or enroll in a user account.

In some embodiments, electronic payment acceptance devices 100 may be used in a retail context as well in order to facilitate the shopping for, ordering of, and/or payment for desired items. The electronic payment acceptance devices may be provided in a fixed location in a manner similar to a cash register or may be hand-held by clerks or employees of a retail store. In addition, they may provide Internet access so that a customer may access additional information about an item he or she wants to buy.

In another embodiment, an electronic payment acceptance device 100 may be used in a package delivery context whereby the user's interaction with electronic payment acceptance device 100 may serve to indicate receipt of a package and/or provide a vehicle by which a delivery person may accept payment for a package.

We claim:

1. A security-status-indicating graphic user interface (GUI) to be displayed on a display window resident in an electronic payment acceptance device, the GUI comprising:
a security message element, the security message element providing an indication that the electronic payment acceptance device is operating in at least one of a secure mode and an unsecure mode, the security message element being displayed at random locations on the display window; and
a modified GUI provided by a software application running on the electronic payment acceptance device, the modified GUI having been modified from a first size provided by the software application to a second size, the second size allowing for concurrent display of the security message element and the modified GUI on the security-status-indicating GUI.

2. The security-status-indicating GUI of claim 1, wherein a portion of the security-status-indicating GUI is obscured by a privacy screen when the electronic payment acceptance device is operating in a secure mode.

3. The security-status-indicating GUI of claim 1, wherein the modified GUI includes a PIN entry graphic element and a position of the PIN entry graphic element on the modified GUI is randomly determined.
